(19) United States
(12) Patent Application Publication
(10) Pub. No.: US 2026/0200226 A1
(43) Pub. Date: Jul. 16, 2026

(54) CHARGE ELECTRODE ASSEMBLY AND METHOD OF ALIGNING COMPONENTS OF A PRINTHEAD

(71) Applicant: Videojet Technologies Inc., Wood Dale, IL (US)

(72) Inventors: David Andrew Horsnell; Michael Jeffrey Stamp; Ben Tuncay Arslan; Bartosz Marcin Oprzadek; David Doswell; Samuel Lorenz

(21) Appl. No.: 19/138,233

(22) PCT Filed: Dec. 14, 2023
(86) PCT No.: PCT/GB2023/053250

§ 371 Date: Jun. 12, 2025

(30) Foreign Application Priority Data
Dec. 15, 2022 (GB) 2218947.6
Dec. 15, 2022 (GB) 2218955.9

(51) Int. Cl. B41J 2/085; B41J 2/02; B41J 2/09; B41J 2/12; B41J 2/185

(52) U.S. Cl. CPC B41J 2/085; B41J 2/02; B41J 2/09; B41J 2/12; B41J 2/185; B41J 2002/1853

(57) ABSTRACT

A charge electrode assembly for a continuous ink jet printer. The charge electrode comprises a charge electrode defining a passage for charging ink droplets, the passage extending from an inlet aperture to an outlet aperture along an ink travel axis, along which an ink jet travels from a nozzle during printing, the electrode being configured to induce a charge on selected ink droplets by capacitive coupling. The charge electrode further comprises a mounting arrangement configured to couple the charge electrode to a nozzle body, the mounting arrangement being configured to permit movement of the charge electrode relative to the nozzle to compensate for ink jet misalignment.

### FIELD

The present invention relates to a charge electrode for a print head of a continuous inkjet (CIJ) printer, a print head for a continuous inkjet printer, a continuous inkjet printer, and associated methods.

### BACKGROUND

In inkjet printing systems, the print is made up of individual droplets of ink generated at a nozzle and propelled towards a substrate. There are two principal systems: droplet on demand, where ink droplets for printing are generated as and when required; and continuous inkjet (CIJ) printing, in which droplets are continuously produced and only selected ones are directed towards the substrate, the others being recirculated to an ink system.

CIJ printers supply pressurised ink to a print head droplet generator where a continuous stream of ink emanating from a nozzle is broken up into individual regular droplets by, for example, an oscillating piezoelectric element. The droplets are directed past a charge electrode, where they are selectively and separately given a predetermined charge, before passing through a transverse electric field provided across a pair of deflection plates, the pair comprising a high voltage (or extra high tension (EHT)) plate and a zero or negative voltage plate (the ‘ground’ plate). Each charged droplet is deflected by the field by an amount that is dependent on its charge magnitude before impinging on the substrate, whereas the uncharged droplets proceed without deflection and are collected at a gutter from where they are recirculated to the ink system. The charged droplets bypass the gutter and hit the substrate at a position determined by the charge on the droplet and the position of the substrate relative to the print head. Typically, the substrate is moved relative to the print head in one direction and the droplets are deflected in a direction generally perpendicular thereto, although the deflection plates may be oriented at an inclination to the perpendicular to compensate for the speed of the substrate (the movement of the substrate relative to the print head between droplets arriving means that a line of droplets would otherwise not quite extend perpendicularly to the direction of movement of the substrate). The various components of the print head are typically contained within a cover tube or print head casing.

In CIJ printing, a character is printed from a matrix comprising a regular array of potential droplet positions. Each matrix comprises a plurality of columns (strokes), each being defined by a line comprising a plurality of potential droplet positions (e.g. seven) determined by the charge applied to the droplets. Thus, each usable droplet is charged according to its intended position in the stroke. If a particular droplet is not to be used then the droplet is not charged and it is captured at the gutter for recirculation. This cycle repeats for all strokes in a matrix and then starts again for the next character matrix.

Ink is delivered under pressure to the print head by an ink system that is generally housed within a sealed compartment of a cabinet that includes a separate compartment for control circuitry and a user interface panel. The ink system includes a main pump that draws the ink from a reservoir or tank (often referred to as a mixing tank) via a filter and delivers it under pressure to the print head. As ink is consumed, the reservoir is refilled as necessary from a replaceable ink cartridge that is releasably connected to the reservoir by a supply conduit. The ink is fed from the reservoir via a flexible delivery conduit to the print head. The unused ink droplets captured by the gutter are recirculated to the reservoir via a return conduit by a pump. The flow of ink in each of the conduits is generally controlled by solenoid valves and/or other like components.

As the ink circulates through the system, there is a tendency for it to thicken because of solvent evaporation, particularly in relation to the recirculated ink that has been exposed to air in its passage between the nozzle and the gutter. In order to compensate for this, “make-up” solvent is added to the ink as required from a replaceable solvent cartridge to maintain the ink viscosity within desired limits. The ink and solvent cartridges are filled with a predetermined quantity of fluid and generally releasably connected to the reservoir, or mixing tank, of the ink supply system so that the reservoir can be intermittently topped-up by drawing ink and/or solvent from the cartridges as required.

CIJ printers generally operate in high throughput environments for which the printers, and inks, need to be able to keep up with high production line speeds, fast drying time requirements and virtually non-stop production.

A problem faced by operators of existing continuous inkjet printers is that of undesirable build-up of deposits within, and around, the print head. Deposits include ink ‘fur’, created by ink pigment which remains after the fluid component of the ink (and solvent mixture) has evaporated. Such deposits risk the accuracy of printing, the operation of the print head, and, in extreme circumstances, may result in the blocking of an ink ejection aperture of the print head (e.g. rendering the print head non-operational for at least a period of time). Presently, the print head must be manually cleaned, sometimes requiring at least partial disassembly of the print head, to remove the aforementioned deposits. This is undesirable for reasons of complexity, operator intervention, print head downtime and the quality of the cleaning.

Continuous inkjet printheads typically induce a charge on the ink drops by providing a charged conductive element, known as the charge electrode, at the point of jet breakup. The charge electrode may comprise a flat plate, slotted rod or bore having windows. It is desirable to inspect the jet for diagnostic purposes. Inspection typically comprises observation of jet break-up and determination of the velocity and phase of the droplet stream. Velocity and phase determination of the droplet stream typically is performed by means of one or more phase detectors and one or more velocity detectors downstream of the charge electrode. Observation of jet break-up is facilitated by a LED strobe backlight and accompanying optics adjacent to, or integrated with the charge electrode. The phase and velocity detectors must be in close and even proximity (i.e. the jet and charge electrode assembly are in coaxial alignment) to the jet in order to ensure sufficient and consistent signal strength respectively.

In use, the undeflected jet trajectory is adjusted so as to land in the gutter, however the alignment of the charge electrode and the jet are generally independent of each other. As a result, such adjustments can disturb the axial alignment between the charge electrode and the jet. In cases where the jet trajectory is substantially adjusted, the charge electrode can interfere with the jet trajectory-a phenomenon referred to as ‘clipping’, which substantially prevents any printing.

Non-coaxial alignment of the electrode and the jet may also result in lateral forces being applied to the droplet stream. The lateral forces result from the unequal lateral distance between electrode surfaces and the droplet and thus an electrostatic force imbalance. As a consequence of which, there is a reduction in print quality and/or collision with the gutter.

There exists a need to provide an alternative charge electrode and print head for a continuous inkjet (CIJ) printer that overcomes one or more of the disadvantages of known systems, whether mentioned in this document or otherwise.

### SUMMARY

According to a first aspect of the invention there is provided a charge electrode assembly for a continuous ink jet printer. The charge electrode comprises a charge electrode defining a passage for charging ink droplets, the passage extending from an inlet aperture to an outlet aperture along an ink travel axis, along which an ink jet travels from a nozzle during printing, the electrode being configured to induce a charge on selected ink droplets by capacitive coupling. The charge electrode further comprises a mounting arrangement configured to couple the charge electrode to a nozzle body, the mounting arrangement being configured to permit movement of the charge electrode relative to the nozzle to compensate for ink jet misalignment.

Manufacturing tolerances in inkjet nozzles may result in ink jet misalignment. This can be accommodated by adjusting the relative position between a gutter configured to catch un-printed ink droplets and the nozzle. However, any jet misalignment may result in imperfect alignment between the ink jet (and ink droplets, once separated from the ink jet) and the charge electrode. This can have a variety of detrimental effects of print quality, including, for example, distortion to the amount of charge induced on droplets, disturbance to the droplet direction, and even, in severe circumstances, collision between the droplets and the charge electrode.

By providing a mounting arrangement that couples the change electrode to the nozzle, while also permitting the charge electrode position to be adjusted, the effects of any jet misalignment can be mitigated. That is, by mounting the charge electrode to the nozzle (rather than to a printhead deck, for example), any movement or adjustment of the nozzle (e.g. to ensure alignment of the ink jet with the gutter) will also cause a corresponding movement of the charge electrode).

The mounting arrangement may comprise an adjustment configuration in which movement of the charge electrode relative to the nozzle to compensate for ink jet misalignment is permitted, and a fixed configuration configured in which movement of the charge electrode relative to the nozzle is not permitted.

In this way, adjustments can be made during a manufacturing, assembly, servicing, or calibration operation, with an adjusted charge electrode configuration then being fixed for subsequent use during printing operations.

The passage may have a first dimension in a first direction perpendicular to a nominal ink travel axis, and a second dimension different to the first dimension in a second direction, the second direction being perpendicular to the first direction and the nominal ink travel axis.

By providing a passage that does not have circular symmetry relative to the nominal ink travel axis (i.e. different dimensions in directions perpendicular to the nominal ink travel axis), a convenient mechanism for providing accurate positioning between the charge electrode and the ink jet can be achieved. For example, the charge electrode can be rotated so that the jet is centred between opposing passage walls.

The nominal ink travel axis may also be referred to a central printhead axis and refers to an expected direction of travel of ink from the nozzle. It will be understood, however, that manufacturing tolerances may result in a (small) misalignment between the ink jet direction (i.e. the ink travel axis) and the central printhead axis (e.g. up to 1.5 degrees). The components of the printhead (e.g. the nozzle body, gutter etc.) will have been designed based upon the central printhead axis, or nominal in travel axis. However, the actual ink travel axis may vary between printheads, and may be not be determined until the components of the printhead have been assembled.

The mounting arrangement may be configured to permit rotation of the charge electrode relative to the nozzle.

By rotating the charge electrode relative to the nozzle, the relative position of the passage walls to the ink jet can be adjusted. For example, where the passage does not have circular symmetry, the charge electrode can be rotated so as to cause the jet to be centred between opposing passage walls.

The mounting arrangement may be configured to permit rotation of the charge electrode relative to the nozzle about a rotation axis that is substantially co-axial with a nominal ink travel axis.

The mounting arrangement may be configured to permit rotation of the charge electrode relative to the nozzle through an angular extent of at least 45 degrees, and optionally wherein the mounting arrangement is configured to permit rotation of the charge electrode relative to the nozzle through an angular extent of up to around 90 degrees.

By providing a rotation extent of 90 degrees in either direction, it is possible to compensate for jet misalignment in any direction.

The mounting arrangement may be configured to permit rotation of the charge electrode relative to the nozzle through an angular extent of up to around 180 degrees. By providing a rotation extent of 180 degrees, in combination with a passage having an elongate cross section (i.e. different first and second dimensions), it is possible to compensate for jet misalignment in any direction, since the longer of the two dimensions can be aligned with the direction of jet misalignment.

The mounting arrangement may be configured to permit rotation of the charge electrode relative to the nozzle through an unlimited extent.

The mounting arrangement may be configured to permit relative movement between the charge electrode and the nozzle in a movement plane perpendicular to the nominal ink travel axis.

That is, the permitted relative movement may not include relative movement along the nominal ink travel axis, but may allow movement (e.g. rotation) of the parts relative to one another in the movement plane (e.g. by sliding past one another).

The mounting arrangement may comprise a guide surface, and a guide element configured to be guided by the guide surface. The extent of movement permitted between the charge electrode and the nozzle may be at least partially determined by the configuration of the guide surface and the guide element.

The interaction of the guide surface and the guide element may thus provide a restricted extent of permitted movement. The guide surface may comprise a guide slot within which the guide element moves. The guide slot may extend in a movement direction. The charge electrode assembly may comprise two guide slots, disposed on opposite sides of the central axis.

One of the guide surface and the guide element may have a fixed configuration relative to the charge electrode in the movement plane. The other one of the guide surface and the guide element may have a fixed configuration relative to the nozzle in the movement plane.

In this way, movement of the guide element past the guide surface (e.g. within a guide slot, socket and/or hole) permits movement of the charge electrode relative to the nozzle in the movement plane, with the extent of movement being determined by the configuration of the guide surface and the guide element.

The guide element may comprise a fixing element. The charge electrode assembly may comprise an adjustment configuration in which the fixing element is configured to guide the movement of the charge electrode relative to the nozzle, and a fixed configuration configured in which the fixing element is configured to fix the position of the charge electrode relative to the nozzle.

It will be appreciated that when the electrode assembly ‘comprises’ an adjustment and/or fixing configuration this should be taken to mean that the charge electrode assembly defines an adjustment and fixed configuration between which the charge electrode assembly is operable.

The guide element may also be a fixing element (e.g. a screw or bolt or a clamping nut). When tightened, relative movement can be prevented, but when loosened the charge electrode can be rotated relative to the nozzle.

The guide surface may comprise a substantially cylindrical socket and the guide element may comprise a cylindrical projecting portion.

The mounting arrangement may comprise a charge electrode coupling. The charge electrode coupling may be couplable, in use, to each of the charge electrode and the nozzle body.

By providing an intermediate component (i.e. the charge electrode coupling) between the charge electrode and the nozzle, it is possible to provide electrical isolation between the charge electrode and the nozzle, while allowing them to be mechanically coupled together.

The charge electrode coupling may define the guide surfaces (e.g. slots or sockets), and may be rigidly coupled to one of the charge electrode and the nozzle, and slidably coupled to the other of the charge electrode and the nozzle. The guide surfaces may be integrally formed within the charge electrode coupling. The guide surfaces may be integrally formed with one of the nozzle body and the charge electrode.

The slidable coupling may permit rotational sliding motion, in an adjustment configuration.

The charge electrode coupling may comprise an annular component configured to surround (e.g. and be centred around) the central printhead axis, defining a central aperture for receiving part of the nozzle and/or part of the charge electrode. In this way, accurate alignment between the nozzle and the charge electrode can be provided.

The charge electrode coupling may comprise an electrical insulator configured to electrically insulate the charge electrode from the nozzle body.

A seal may be provided between the charge electrode and the nozzle.

In this way, it is possible to provide a sealable cavity extending from the nozzle orifice to the ink ejection aperture, allowing the cavity to be cleaned.

The charge electrode assembly may comprise a first seal between the guide and the charge electrode, and a second seal between the guide and the nozzle. An O-ring or gasket may be provided at the or each of the first and second seals.

The guide surface may comprise a substantially cylindrical socket defined by the nozzle body and the guide element may comprise a cylindrical projecting portion defined by the charge electrode coupling.

The guide element and guide surface form concentric cylindrical interfaces between the charge electrode coupling and the nozzle body, permitting their relative rotation.

In an alternative, the guide surface may comprise a substantially cylindrical socket defined by the charge electrode coupling and the guide element may comprise a cylindrical projecting portion defined by the nozzle body.

The mounting arrangement may comprise a further guide element defined by the nozzle body comprising a cylindrical projecting portion and the charge electrode which may define a further guide surface, comprising a socket.

The mounting arrangement may comprise a clamping nut, wherein the clamping nut comprises a threaded portion, configured to thread onto the nozzle body and a shoulder configured to hold the charge electrode coupling against the nozzle body. In use, the clamping nut may be operable by turning between the adjustment configuration where the charge electrode coupling is loosely held and the fixed configuration where the charge electrode coupling is compressed against the nozzle body by the shoulder, restricting axial and rotational movement of the charge electrode relative to the nozzle.

Advantageously the clamping nut arrangement does not restrict the rotation of the charge electrode coupling about its axis.

The charge electrode assembly may further comprise a bearing member which at least partially defines a spherical surface, coupled to the charge electrode. The bearing member may be configured to be pivotally coupled to a charge electrode mount, forming a ball-joint, permitting rotation of the charge electrode in two distinct planes about a centre of rotation.

The first dimension may be at least 0.5 mm. The first dimension may be less than 1 mm. The second dimension may be at least 1 mm. The second dimension may be less than 5 mm.

By providing a charge electrode passage having a slot-like shape, it is possible to provide a close separation between the passage walls and the ink jet at the ink break-up point (due to the smaller dimension), and a degree of insensitivity to jet mis-alignment (due to the larger dimension). Rotation of the charge electrode, permits the separation in the smaller dimensions to be oriented so that the walls are substantially the same distance from the ink jet on each side, thereby promoting even charging, and avoiding unnecessary droplet distortion and deflection. On the other hand, the larger dimension can be aligned with a plane defined by the ink travel axis and the nominal ink travel axis.

The first dimension may be between around 0.6 mm and around 0.7 mm. The second dimension may be between around 1.2 mm and around 1.5 mm.

The charge electrode may comprise first and second axially disposed regions. The first region may be configured to induce a charge on selected ink droplets by capacitive coupling. The second region may be configured to shield the charged ink droplets by surrounding at least a segment of said travel axis.

That is, the first region may enclose the passage from the inlet aperture to a jet breakup location. The second region may enclose the passage from the jet breakup location to the outlet aperture. In this way, the charged droplets may be shielded from external electromagnetic interference (e.g. a HT field used for deflecting droplets).

The first and the second axially disposed regions may be located one on either side of the viewing aperture.

The passage may have the first and second dimensions in at least a portion of the first axially disposed region. The passage may have a third dimension in the first direction and a fourth dimension in the second direction in at least a portion of the second axially disposed region. The third dimension may be larger than the first dimension. The fourth dimension may be larger than the second dimension.

That is, the first region may have relatively small dimensions between the inlet aperture and the jet breakup location, so as to provide a reliable coupling between the charge electrode and the ink jet (and droplets, as they are formed), without needing excessively high charge electrode voltages to be applied.

The second region which encloses the passage from the droplet breakup location to the outlet aperture may primarily shield the droplets, and may, therefore not require such small dimensions. By providing larger dimensions, it is possible to allow increased tolerance for jet misalignment.

The passage may be referred to as an enclosed passage. The passage may be partially enclosed.

The passage may be fully enclosed. That is, the inlet and outlet apertures may define the only openings to the enclosed passage through which fluid can pass. In this way, the charge electrode can be sealed to the nozzle and a printhead housing, facilitating the provision of an enclosed cleaning chamber.

At least a portion of the charge electrode may be transparent, such that the charge electrode is configured to permit monitoring the formation of the ink droplets within the passage.

The charge electrode may comprise a transparent body. It will be appreciated that 100% transparency is not required, rather a sufficient degree of transparency to allow the jet breakup position to be viewed.

The charge electrode may comprise a transparent by conductive charge electrode body. The charge electrode may comprise a transparent and non-conductive charge electrode body having a transparent conductive coating (e.g. an ITO-sputtered transparent plastic component).

The charge electrode may comprise a viewing aperture for monitoring the formation of the ink droplets within the passage.

By providing a viewing aperture, it is possible to view the jet breakup location within the charge electrode. The viewing aperture may be closed by a transparent window, allowing the passage to remain sealed from the region outside the charge electrode, while still permitting the internal passage to be viewed.

The charge electrode may further comprise a light source or a second viewing aperture disposed on an opposite side of the travel axis from the viewing aperture.

By providing a pair of opposed viewing apertures or a single viewing aperture and opposed light source, it is possible to view the jet breakup location through the charge electrode, while providing a (e.g. strobed) backlight to enhance clarity of imaging.

The viewing aperture(s) may have an elongated shape that extends in the direction of the travel axis.

There is also provided an assembly for a printhead for a continuous inkjet printer, the assembly comprising a charge electrode assembly having one or more of the features described above, and the nozzle.

There is also provided a printhead for a continuous inkjet printer comprising a charge electrode assembly according to the first aspect of the invention.

The printhead may further comprise the nozzle, for generating and ejecting an ink jet which subsequently undergoes jet breakup into a stream of ink droplets for printing.

The printhead may further comprise a deflection electrode, configured to deflect droplets of ink after they have been charged by the charge electrode.

The printhead may further comprise a gutter for receiving droplets of ink that are not used for printing.

The printhead may further comprise a printhead housing, configured to enclose the deflection electrode within a cleaning chamber, the printhead defining a seal between the charge electrode and the cleaning chamber. The printhead housing may also be referred to as a chamber housing.

In this way, the internal volume defined within the printhead housing (i.e. the cleaning chamber) can be flooded with solvent to clean away any ink deposits, allowing the internal passage of the charge electrode and the surface of the deflection electrode to be cleaned efficiently.

The printhead may further comprise a flexible member disposed between the charge electrode and the printhead housing configured to provide the seal, the flexible member being configured to permit movement between the printhead housing and the charge electrode.

In this way, adjustments can be made to the charge electrode (and possible attached nozzle) without also moving the printhead housing. The flexible member may be referred to as a boot. The flexible member can ensure that a fluid seal is retained, while accommodating some movement.

The printhead may further define an ink aperture configured to permit droplets to exit the printhead for printing. The printhead may comprise a sealing mechanism configured to selectively close the ink aperture.

The sealing mechanism may comprise any convenient arrangement (e.g. a rotating shutter, a pneumatic or hydraulic shutter, a sliding cover, etc.) When the ink aperture is closed by the sealing mechanism, an enclosed fluid volume may be defined between the nozzle and the ink aperture, a portion of the enclosed fluid volume being defined by the charge electrode passage.

The printhead may further comprise a nozzle adjustment mechanism. The nozzle adjustment mechanism may be configured to permit adjustment of the nozzle relative to the gutter to compensate for ink jet misalignment.

The nozzle adjustment mechanism may comprise first and second adjustment screws, each configured to provide adjustment in mutually orthogonal axes, the mutually orthogonal axes being perpendicular to the ink travel axis.

There is also provided a continuous inkjet printer comprising a print head as described above. The continuous inkjet printer may further comprise an ink system for storing ink and supplying ink to the print head.

According to a second aspect of the invention, there is provided a method of configuring a print head for a continuous inkjet printer. The method comprises adjusting a nozzle of the printhead to align an ink jet ejected from the nozzle with a gutter for receiving droplets of ink that are not used for printing. The method further comprises securing the nozzle to a body of the printhead in an aligned configuration, adjusting a position of a charge electrode relative to the nozzle to compensate for ink jet misalignment, and securing the charge electrode to the nozzle in an adjusted configuration.

Adjusting a position of a charge electrode relative to the nozzle to compensate for ink jet misalignment may comprise rotating the charge electrode relative to the nozzle.

Compensating for ink jet misalignment may comprise positioning the charge electrode relative to the jet so that a charge electrode passage is substantially centred relative to the jet in at least one direction.

The method of the second aspect may further comprise one or more optional features described above in combination with the charge electrode, printhead and continuous inkjet printer of the first aspect.

According to a third aspect of the invention there is provided a charge electrode assembly for a continuous inkjet printer. The charge electrode assembly comprises: a charge electrode defining a passage for charging ink droplets, the passage extending from an inlet aperture to an outlet aperture along an ink travel axis, along which an ink jet travels from a nozzle during printing, the electrode being configured to induce a charge on selected ink droplets by capacitive coupling; and a bearing member which at least partially defines a spherical surface, coupled to the charge electrode. The bearing member is configured to be pivotally coupled to a charge electrode mount, forming a ball-joint, permitting rotation of the charge electrode in two distinct planes about a centre of rotation.

Advantageously, a ball-joint allows easy adjustment of the ink jet to compensate for misalignment of the inkjet and the gutter, whilst simultaneously hydraulically sealing a cleaning chamber of a printhead.

The bearing member may comprise a toroidal flange provided co-axially, around the charge electrode passage.

The toroidal flange may define a truncated spherical surface disposed circumferentially about the charge electrode passage.

The charge electrode assembly may further comprise a mounting arrangement configured to couple the charge electrode to a nozzle body, the mounting arrangement being configured to permit rotational movement of the charge electrode relative to the nozzle.

Advantageously, rotational movement of the charge electrode relative to the nozzle enables compensation for ink jet misalignment.

The mounting arrangement may comprise: a charge electrode coupling, configured to couple the charge electrode and nozzle body; and a clamping nut. The clamping nut may comprise a threaded portion, configured to thread onto the nozzle body; and a shoulder configured to hold the charge electrode coupling against the nozzle body. In use, the clamping nut may be operable by turning between an adjustment configuration where the charge electrode coupling is loosely held and a fixed configuration where the charge electrode coupling is compressed against the nozzle body by the shoulder, restricting axial and rotational movement of the charge electrode relative to the nozzle.

Advantageously the clamping nut arrangement, does not restrict the rotation of the charge electrode coupling about its axis.

The socket and bearing member may be configured to form a hydraulic seal in a plurality of relative orientations.

According to a fourth aspect of the invention there is provided a printhead for a continuous inkjet printer comprising a charge electrode assembly of the third aspect of the invention. The charge electrode assembly may comprise any of the optional features described above. The printhead further comprises; the nozzle, for generating and ejecting an ink jet which subsequently undergoes jet breakup into a stream of ink droplets for printing; a deflection electrode, configured to deflect droplets of ink after they have been charged by the charge electrode; and a gutter for receiving droplets of ink that are not used for printing; and a charge electrode mount configured to be pivotally coupled to the bearing member, forming a ball-joint, permitting rotation of the charge electrode in two distinct planes about a centre of rotation.

The charge electrode mount may define a socket, configured to receive the bearing member.

The socket may be toroidal.

Advantageously, the toroidal shape of the socket permits passage of the inkjet through the socket and thus the ball-joint.

The socket may be a truncated spherical surface.

The socket may be integrally formed with a chamber housing.

The printhead may be configured to permit the charge electrode to rotate up to 10 degrees away from a nominal ink travel axis about the centre of rotation.

The nozzle and the charge electrode may be axially coupled.

The gutter may be rigidly coupled to the charge electrode mount by a single part.

The chamber housing may comprise the single part.

According to a fifth aspect of the invention there is provided a modular printhead for a continuous inkjet printer. The modular printhead comprises: a sealing mechanism releasably coupled to a housing assembly at an interface. The sealing mechanism comprises: a rotatable body rotatable about an axis of rotation between a first configuration and a second configuration; and a casing defining an ink aperture, the casing retaining the rotatable body. The housing assembly comprises: a chamber selectively sealable by the rotatable body rotatable about an axis of rotation between a first configuration having an open ink aperture and a second configuration having a closed ink aperture; a nozzle for generating and ejecting a stream of ink droplets for printing; at least one electrode for guiding the stream of ink droplets; and a gutter for receiving droplets of ink which are not used for printing. The at least one electrode is disposed in the chamber; and at least one fluid pathway, and at least one mechanical coupling, extend across the interface.

Advantageously the releasable coupling of the housing assembly and sealing mechanism of the modular printhead facilitates easy disassembly and maintenance of the modular printhead.

The fluid pathway extending across the interface may comprise a connection block, the connection block being configured to provide a detachable fluid connection across the interface.

The gutter may be configured to remain in situ relative to the chamber when the sealing mechanism is decoupled from the housing assembly.

According to a sixth aspect of the invention there is provided a method of disassembling a modular printhead of the fifth aspect. The modular printhead may comprise any of the optional features described above. The method comprises: decoupling the sealing mechanism from the housing assembly at the interface, separating the at least one fluid pathway across the interface, and disengaging the mechanical coupling across the interface.

According to a seventh aspect of the invention there is provided a method of aligning components of a printhead for a continuous inkjet printer, the method comprising: adjusting a position of a charge electrode relative to a nozzle to compensate for ink jet misalignment; securing the charge electrode to the nozzle in an adjusted configuration; fitting a charge electrode into a charge electrode mount, forming a ball-joint mount; adjusting an orientation of the charge electrode by rotating the charge electrode relative to a body of the printhead about the ball joint mount to align an ink jet ejected from the nozzle with the gutter for receiving droplets of ink that are not used for printing; and securing the nozzle to a body of the printhead in an aligned configuration.

Adjusting the position of the charge electrode relative to the nozzle may be performed before fitting the charge electrode into the charge electrode mount, forming a ball-joint mount.

Adjusting the charge electrode prior to fitment into the charge electrode mount is advantageous because the access to the charge electrode for adjustment is not impeded by the charge electrode mount, for example.

The nozzle and charge electrode may be secured together to form a single assembly. Advantageously, securing the nozzle and charge electrode to each other in an aligned configuration allows the orientation of the charge electrode and the nozzle relative to the body of the printhead to be adjusted in tandem as a single assembly, while preserving the alignment between the nozzle and charge electrode.

The method may further comprise attaching a sealing mechanism.

The printhead may be attached to a test fixture for some or all of the method.

The orientation of the charge electrode may be adjusted by means of an external alignment tool.

Advantageously, use of an external alignment tool eliminates the need to build in the alignment components into each printhead, saving cost.

The charge electrode may be snap-fitted into a charge electrode mount.

The method may further comprises detaching a sealing mechanism from the printhead, to expose a gutter.

The sealing mechanism is configured to releasably couple to a housing assembly at an interface, the sealing mechanism comprising:
a rotatable body rotatable about an axis of rotation between a first configuration and a second configuration; and
a casing defining an ink aperture, the casing retaining the rotatable body;
   wherein the housing assembly comprises a chamber selectively sealable by the rotatable body rotatable about an axis of rotation between a first configuration having an open ink aperture and a second configuration having a closed ink aperture; and further wherein at least one fluid pathway, and at least one mechanical coupling, extend across the interface.

The housing assembly may further comprise a nozzle for generating and ejecting a stream of ink droplets for printing; at least one electrode for guiding the stream of ink droplets; and a gutter for receiving droplets of ink which are not used for printing.

The method may be part of a method of manufacturing a printhead.

According to an eighth aspect of the invention there is provided a printhead for a continuous inkjet printer. The printhead comprises: a nozzle for generating and ejecting an ink jet which subsequently undergoes jet breakup into a stream of ink droplets for printing; a charge electrode defining an enclosed passage for charging ink droplets, the enclosed passage extending from an inlet aperture to an outlet aperture along an ink travel axis, along which the ink jet travels from the nozzle during printing, the electrode being configured to induce a charge on selected ink droplets by capacitive coupling; a deflection electrode, configured to deflect droplets of ink after they have been charged by the charge electrode; a gutter for receiving droplets of ink that are not used for printing; and an ink aperture configured to permit droplets to exit the printhead for printing. The printhead has a printing configuration in which the ink aperture is open, and a cleaning configuration in which the ink aperture is closed. In the cleaning configuration, the printhead defines an enclosed cleaning chamber, the enclosed cleaning chamber being at least partly defined by the enclosed passage.

That is, by partly defining a cleaning chamber by the charge electrode passage it is possible to define a minimum cleaning volume required for cleaning, since only the internal surface (i.e. the enclosed passage) of the charge electrode will require cleaning. That is, the external surface of the charge electrode may thus be excluded from the cleaning chamber, reducing the volume requiring cleaning, and thereby reducing the volume of cleaning fluid required for cleaning.

The droplets of ink received by the gutter may be uncharged and/or undeflected; and the ink aperture may be configured to exclusively permit the selected ink droplets for printing to exit the printhead.

The selected ink droplets should be taken to mean those charged by the charge electrode, having been deflected by the deflection electrode and only selected ink droplets are directed towards a substrate for printing.

The ink aperture may be spaced apart from the nozzle by the enclosed cleaning chamber. That is, the droplets may traverse the cleaning chamber (which, during printing, is not entirely enclosed) when travelling from the nozzle to the ink aperture during printing.

The enclosed cleaning chamber may have a variable geometry.

The printhead may further comprise a printhead housing. The enclosed cleaning chamber may be at least partly defined by the printhead housing. The printhead may define a seal between the printhead housing and the charge electrode.

The enclosed passage may be fully enclosed. That is, the inlet and outlet apertures may define the only openings to the enclosed passage through which fluid can pass. In this way, the charge electrode can be sealed to the nozzle and printhead housing, facilitating the provision of the enclosed cleaning chamber.

The printhead may comprise a flexible member disposed between the charge electrode and the printhead housing configured to provide the seal. The flexible member may be configured to permit adjustment between the printhead housing and the charge electrode.

In this way, adjustments can be made to the charge electrode (and possibly attached nozzle) without also moving the housing. The flexible member may be referred to as a boot. The flexible member can ensure that a fluid seal is retained, while accommodating some movement.

The charge electrode and the printhead housing may be movably coupled so as to permit relative movement between the printhead housing and the charge electrode.

The charge electrode and the printhead housing may be pivotally coupled so as to permit adjustment between the printhead housing and the charge electrode.

The printhead may comprise a ball joint, the ball joint comprising: a bearing member which at least partially defines a spherical surface, coupled to the charge electrode; and a charge electrode mount, coupled to the printhead housing, defining a socket which retains the bearing member. The bearing member and charge electrode mount may form a ball-joint, permitting rotation of the charge electrode in two distinct planes about a centre of rotation.

The socket and bearing member provide a moveable, hydraulically-sealed interface.

The printhead may define a seal between the nozzle and the charge electrode. The cleaning chamber may be at least partly defined by the nozzle.

The charge electrode may be moveable with respect to both the printhead housing and the nozzle.

The printhead may comprise one or more conduits in communication with the enclosed cleaning chamber via one or more corresponding ports.

The conduits and ports may be used to provide cleaning fluid to the chamber and to drain cleaning fluid from the gutter. The conduits and ports may be used to provide and/or vent gas (e.g. air) to/from the chamber.

At least one of the one or more ports may be disposed in the nozzle. In this way, it is possible to drain residual cleaning fluid from within the charge electrode.

At least one of the one or more ports may be disposed proximate to the charge electrode. In this way, it is possible to drain residual cleaning fluid from within the charge electrode.

At least one of the one or more ports may be disposed proximate to the gutter. In this way, it is possible to drain residual cleaning fluid from an end of the printhead distal from the nozzle. The gutter may provide at least one of the one or more ports.

The one or more ports may be configured to fill, supply or drain the enclosed chamber with a cleaning fluid.

The one or more ports may be configured to vent air from the enclosed chamber.

The cleaning chamber may thus extend from the nozzle to the ink aperture, allowing all parts along the ink travel axis to be cleaned in a single volume, while also minimising the volume of the cleaning chamber.

The printhead may further comprise a mounting arrangement configured to couple the charge electrode to the nozzle. The mounting arrangement may be configured to permit movement of the charge electrode relative to the nozzle to compensate for ink jet misalignment during an adjustment operation. The mounting arrangement may be configured to rigidly secure the charge electrode to the nozzle during printing.

The mounting arrangement may be a mounting arrangement as provided by the charge electrode assembly of the first aspect. The mounting arrangement may comprise one or more optional features described above in the context of the charge electrode assembly of the first aspect.

The charge electrode enclosed passage may be a volume of rotation about an axis. The volume of rotation may comprise a first narrow parallel section adjoining a second diverging section. The first narrow parallel section may be configured to be adjacent to, and receive the ink jet from, the nozzle.

Advantageously, such a geometry can tolerate large angular misalignment without adjustment due to the relatively large diverging section provided the jet intersects the bore-axis at the first narrow section. Because of its small dimensions and the resultant close proximity to the ink jet, the first section may be configured to provide reliable coupling between the charge electrode and the nascent droplets.

The ink aperture may be disposed downstream of the deflection electrode.

The ink aperture may be disposed proximate to the gutter.

According to a ninth aspect of the invention, there is provided a method of cleaning a print head for a continuous inkjet printer. The method comprises closing an ink aperture of the printhead to define an enclosed cleaning chamber, the enclosed cleaning chamber being at least partly defined by a charge electrode of the printhead. The method further comprises directing a cleaning fluid into the cleaning chamber to clean the chamber. Directing the cleaning fluid into the chamber comprises directing the cleaning fluid into the enclosed passage of the charge electrode, the enclosed passage extending from an inlet aperture to an outlet aperture along an ink travel axis, along which an ink jet travels from a nozzle during printing, the electrode being configured to induce a charge on selected ink droplets by capacitive coupling.

The method may comprise one or more optional features described above with reference to the first and/or third aspects of the invention.

It will be understood that the enclosed passage of the charge electrode may define the enclosed chamber by at least partly enclosing the enclosed chamber.

According to a tenth aspect of the invention there is provided a charge electrode for a continuous inkjet printer. The charge electrode defines an enclosed passage for charging ink droplets. The enclosed passage is a volume of rotation about an axis, the volume of rotation comprises a first narrow parallel section. The first narrow parallel section adjoins a second diverging section. The first narrow parallel section is configured to receive an ink jet from a nozzle and induce a charge on selected ink droplets by capacitive coupling.

Advantageously, such a geometry can tolerate large angular misalignment without adjustment due to the relatively large diverging section provided the jet intersects the bore-axis at the first narrow section. Because of its small dimensions and the resultant close proximity to the ink jet, the first section may be configured to provide reliable coupling between the charge electrode and the nascent droplets.

The second diverging section may have a radius about the axis which substantially monotonically increases along the axis.

The second diverging section may be substantially conical.

The second diverging section may have a radius about the axis which non-monotonically increases along the axis.

The first narrow parallel section may be configured to be in a sealing relationship with the nozzle.

The second diverging section may be configured to be in a sealing relationship with a printhead housing.

The charge electrode may be fabricated at least in part from conductive materials.

The charge electrode may be substantially composed of clear conductive plastic.

Advantageously, construction of the charge electrode facilitates both charge induction on nascent droplets by capacitive coupling and also visual observation of the jet.

The first narrow parallel section may be composed of a narrow metal tube having an observation aperture which is press fit into a wider plastic body.

The charge electrode of the tenth aspect may be used in combination with the printhead of the eighth aspect, and/or the method of the ninth aspect.

More generally, it will further be appreciated that the charge electrode or charge electrode assembly of any of the first, third or tenth aspects may be used in combination with the printhead of any of the fourth, fifth and eighth aspects, and/or the methods of the second, sixth, seventh and ninth aspects.

### BRIEF DESCRIPTION OF FIGURES

Specific embodiments of the present invention will now be described, by way of example only, with reference to the accompanying drawings in which:

FIG. 1 is a schematic illustration of a continuous inkjet (CIJ) printer according to an embodiment of the invention;

FIG. 2 is a perspective view of a print head, of the printer shown in FIG. 1, in isolation;

FIG. 3 is an alternative perspective view of the print head of FIG. 2 with an outer casing omitted;

FIG. 4 is an alternative perspective view of the print head of FIG. 3;

FIG. 5 is a magnified view of part of the print head shown in FIGS. 4 and 5 with a chamber housing omitted;

FIG. 6 is a perspective view of a subassembly of the print head of FIGS. 2 to 5;

FIG. 7 is a cross-section side view of the subassembly of FIG. 6;

FIG. 8 is an alternative cross-section view of the subassembly of FIGS. 6 and 7;

FIG. 9 is a simplified schematic diagram of a fluid system for the printer of FIG. 1; incorporating the print head shown in FIGS. 2 to 7;

FIG. 10 is a cross-sectional view of a charge electrode assembly and adjacent parts of the nozzle body;

FIG. 11 is a perspective view of the charge electrode assembly and adjacent parts of the nozzle body of FIG. 10;

FIG. 12 is a perspective view of the insulating coupling and adjacent parts of the nozzle body of FIGS. 10 and 11;

FIG. 13A is a plan view of a nozzle adjustment mechanism, also showing the attached charge electrode assembly and nozzle body of FIGS. 10, 11 and 12;

FIG. 13B is an alternate view of the nozzle adjustment mechanism and attached charge electrode assembly and nozzle body of FIG. 13A;

FIG. 13C is the view of the nozzle adjustment mechanism and attached charge electrode assembly and nozzle body of FIG. 13B with a nozzle cradle omitted;

FIG. 14A is a view of a transverse cross-section of the enclosed passage of the charge electrode of FIGS. 10-13C in use under an ideal configuration;

FIG. 14B is a view of the transverse cross-section of the enclosed passage of the charge electrode of FIG. 14A in use under a non-ideal configuration;

FIG. 14C is a view of the transverse cross-section of the enclosed passage of the charge electrode of FIGS. 14A and 14B in use after adjustment under the non-ideal configuration of FIG. 14B; and

FIG. 15 schematically illustrates an alternative embodiment of the charge electrode.

FIG. 16 is a cross-sectional view of the charge electrode assembly and part of the printhead, showing an electrical contact arrangement of the charge electrode.

FIG. 17 is a perspective view of the insulating coupling and part of the nozzle body of FIGS. 10, 11 and 12.

FIG. 18A schematically illustrates an alternative insulating coupling arrangement.

FIG. 18B schematically illustrates the alternative insulating coupling arrangement of FIG. 18A in another orientation.

FIG. 19 is a perspective view of a print head according to an another embodiment, in isolation.

FIG. 20 is a perspective view of the printhead of FIG. 19, with internal parts partially exposed.

FIG. 21 is a cross-section side view of the printhead of FIGS. 19 and 20.

FIG. 22 is a cross-section side view of a charge electrode assembly and surrounding components of the printhead of FIGS. 19-21.

FIG. 23A is a perspective view of a charge electrode mount shown in FIG. 22, in isolation.

FIG. 23B is an alternative perspective view of the charge electrode mount shown in FIGS. 22 and 23A, in isolation.

FIG. 24 is a perspective view of a charge electrode coupling shown in FIG. 22, in isolation.

FIG. 25 is a perspective view of a charge electrode shown in FIG. 22, in isolation.

FIG. 26 is a perspective view of a selected part of the printhead of FIGS. 19-21, with internal parts partially exposed.

FIG. 27 is an alternative perspective view of the selected part of the printhead shown in FIG. 26, with internal parts partially exposed.

FIG. 28 shows a part of a shaft shown in FIGS. 21 and 27, in isolation.

FIG. 29 shows a perspective view of another part of the printhead of FIGS. 19-21, with a sealing mechanism removed.

FIG. 30 shows a selected cross-sectional view of the printhead of FIGS. 19-21

FIG. 31 schematically illustrates a method of adjusting the printhead of FIGS. 19-21.

### DETAILED DESCRIPTION

FIG. 1 schematically illustrates a continuous inkjet (CIJ) printer 1 according to an embodiment of the invention. The printer 1 comprises a printer body 2 (which may be referred to as a cabinet) connected to a print head 3 by an umbilical cable 4. The printer body 2 houses an ink system 5 and a printer controller 6. The printer body 2 also has an interface 7 (e.g. a display, keypad, and/or touch screen) for use by an operator.

The print head 3 is arranged to print on a substrate provided adjacent to the print head 3. The printer 1 typically comprises two cartridge connections for engagement with respective fluid cartridges. In particular, the printer 1 comprises an ink cartridge connection for engagement with an ink cartridge 8 and a (separate) solvent cartridge connection for engagement with a solvent cartridge 10. The cartridge connections typically each comprise a fluid port arranged to connect to a fluid pathway within the printer 1 to allow fluid to flow between the cartridges 8, 10 and other parts of the inkjet printer 1, such as the ink system 5 and the print head 3 (via the umbilical 4).

In operation, ink from the ink cartridge 8 and solvent from the solvent cartridge 10 can be mixed within the ink system 5 to generate printing ink of a desired viscosity that is suitable for use in printing. This ink is supplied to the print head 3 and unused ink is returned from the print head 3 to the ink system 5 (via the umbilical 4). When unused ink is returned to the ink system 5 from the print head 3, air may be drawn in with ink from a gutter of the print head 3. The air may then become saturated with solvent in the gutter line.

In operation, ink is delivered under pressure from the ink system 5 to the print head 3 and recycled back via flexible tubes which are bundled together with other fluid tubes and electrical wires (not shown) into the umbilical cable 4. In order to maintain correct consistency of the ink, the ink system 5 may be operable to mix ink removed from the cartridge 8 with solvent removed from the cartridge 10 and to mix them together to obtain an ink having the correct viscosity and/or density for a particular printing application.

Of particular relevance to the present application, the print head 3 is a self-cleaning print head. Without operator intervention, the print head 3 can be sealed, and a cleaning fluid be flushed through at least part of the print head 3, in order to clean the print head 3. As will be set out in the following description and accompanying figures, this is achieved by incorporation of a sealing mechanism, comprising a rotatable body, in the print head 3.

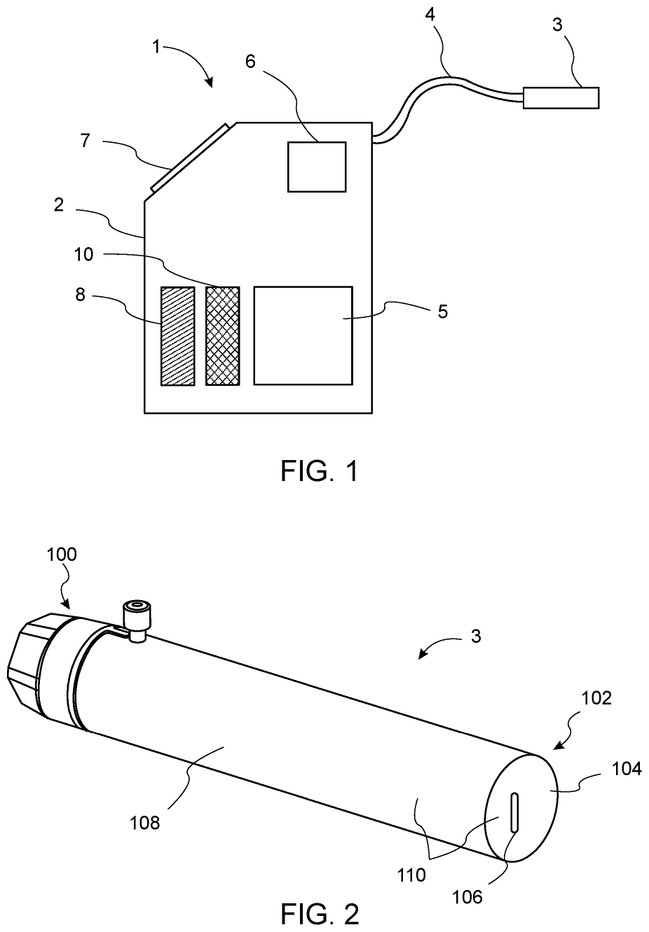

Turning to FIG. 2, a perspective view of the print head 3 in isolation is provided.

The print head 3 comprises a first end 100 by which the print head 3 is connectable to an umbilical 4 as shown in FIG. 1. The first end 100 may therefore comprise a connector (e.g. a threaded connector in the illustrated embodiment). At an opposing end, the print head 3 comprises a second end 102. Provided at the second end 102 is an end cap 104. The end cap 104 defines an outermost part of the print head 3. The end cap 104 comprises an ink aperture 106, which may be referred to as an ink slot. It is through the ink aperture 106 that deflected ink, in operation, is ejected from the print head 3 onto a substrate (e.g. an external substrate which moves past the print head 3). Extending generally between the first and second ends 100, 102 is an outer shell 108. The outer shell 108 is generally cylindrical in the illustrated embodiment and provides a protective cover for the components which make up the print head 3. In order to expose the components, such as for maintenance, the outer shell 108 is removable. The combination of the end cap 104 and the outer shell 108 may be described as an outer cover 110 of the print head 3.

When the print head 3 is to be cleaned (e.g. by way of the self-cleaning capability of the print head 3), the ink aperture 106 can effectively be closed, and sealed, by a sealing mechanism within the print head 3. That is to say, when cleaning fluid is flushed through a chamber of the print head 3 (which will be described below), cleaning fluid cannot escape from the print head 3 through the ink aperture 106. For the purposes of this application, the closing of the ink aperture 106 may not infer a change in the geometry of the ink aperture 106 geometry itself. That is to say, the ink aperture 106 remains as shown in FIG. 2 regardless of whether it is opened or closed (by operation of the sealing mechanism). However, at least in the illustrated embodiment, the ink aperture 106 can be obscured (e.g. covered, internally) by an upstream rotatable body to define the sealed chamber. This will be described in detail later in this document.

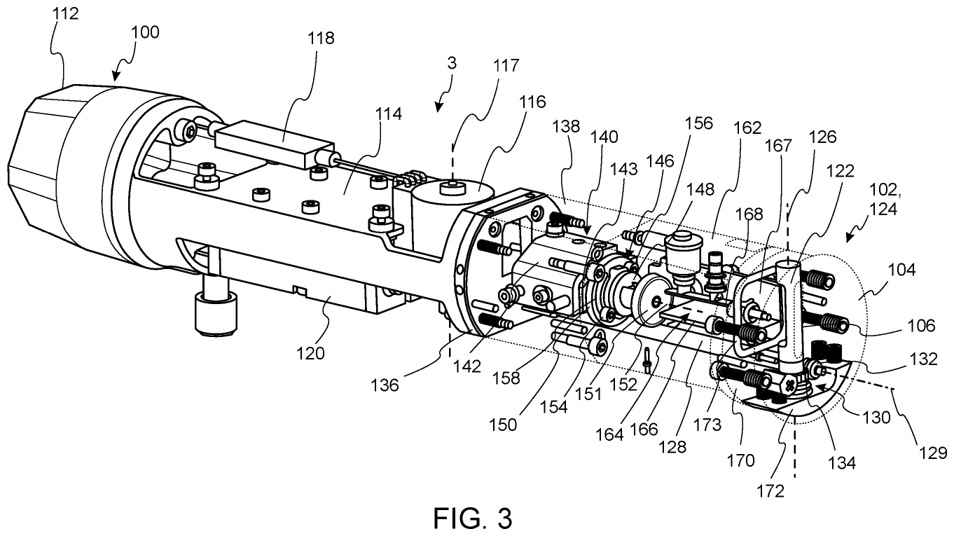

Turning to FIG. 3, a perspective view of the print head 3 is provided with the outer shell 108 omitted. Various components which make up the print head 3 are therefore visible, and a number of components are also shown in a partially cutaway view to improve visibility.

FIG. 3 shows a connector 112, by which the print head 3 is connectable to an umbilical, provided at the first end 100 of the print head. The connector 112 is integral with a chassis 114. The chassis 114 defines a platform of sorts to which various other components are mounted. For example, a motor 116 and high voltage resistor 118 are mounted to the chassis 114 in the illustrated embodiment. The high voltage resistor 118 limits the current and spark energy available to the electrodes (described below). In other embodiments the high voltage resistor 118 may be mounted closer to a deflection electrode 168 to reduce a cable length therebetween. The high voltage resistor 118 may therefore be mounted to a chamber housing 162 or PCB 167, for example. A solenoid valve 120 is also mounted to the chassis 114. In the illustrated embodiment the solenoid valve 120 is mounted to the chassis 114 via a valve manifold. The motor 116 is a stepper motor in the illustrated embodiment, but other varieties of motor may otherwise be used.

A shaft of the motor 116 rotates about an axis of rotation 117, which may be referred to as a motor axis. The motor 116 is provided in power communication with a rotatable body 122 which forms part of a sealing mechanism 124. The sealing mechanism 124 is located at the second end 102 of the print head 3 and, as mentioned above, is a particular focus of the present application. Briefly, the rotatable body 122 is rotatable about an axis of rotation 126. The rotatable body 122 is rotatable between a first configuration, in which an ink path is defined across the rotatable body 122 and through the ink aperture 106, and a second configuration (as shown in FIG. 3) in which the rotatable body 122 closes the ink aperture 106. In the second configuration the sealing mechanism 124, specifically the rotatable body 122 thereof, seals part of the print head 3 (i.e. a chamber) to allow that part to be flushed with cleaning fluid to clean the print head 3.

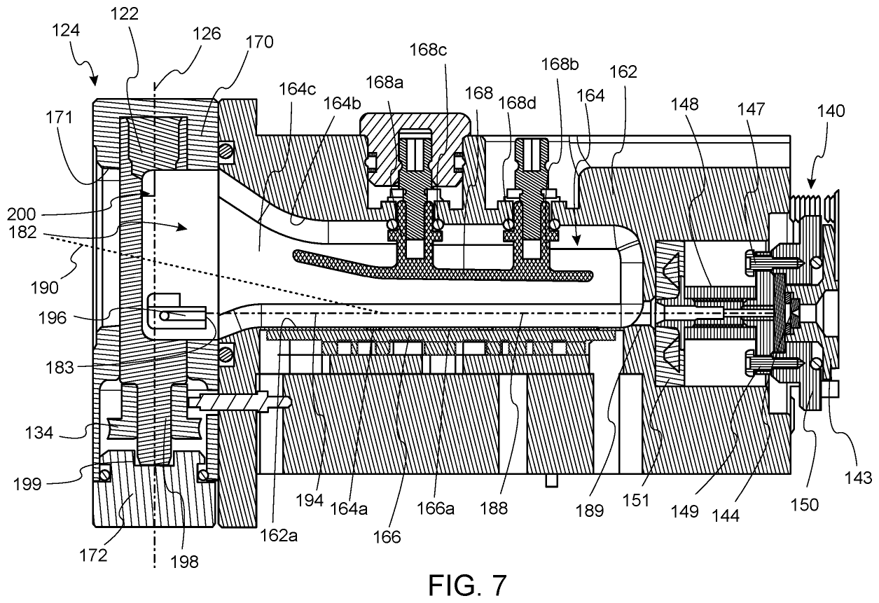

As previously mentioned, the motor 116 is in power communication with the rotatable body 122 to drive rotation of the rotatable body 122. The motor 116 is in power communication with the rotatable body 122 via a shaft 128. The shaft 128 is disposed outside of a chamber which is selectively sealed by the rotatable body 122 (e.g. see chamber 164 in FIG. 7). The shaft 128 extends along an extent of the chamber. The shaft 128 is in power communication with the rotatable body 122 via a worm gear 130 comprising a worm 132 and a gear 134. The worm 132 is coupled to an end of the shaft 128 (e.g. which is proximate the second end 102 of the print head 3). The gear 134 is rotatably coupled to the rotatable body 122. The worm gear 130 changes the direction of rotation of the shaft 128 from the axis of rotation 129 to the axis of rotation 126. Although not visible in FIG. 3 a further worm gear is used to change a direction of rotation of the motor 116 at an obscured end of the shaft 128 (e.g. located towards the first end 100 of the print head 3). As mentioned above, the shaft 128 rotates about the axis of rotation 129. The axis of rotation 129 extends in a longitudinal direction along the print head 3, and the print head 3 may be described as generally extending in the same longitudinal direction.

The use of the drive assembly including the shaft 128 and the worm gear 130 is advantageous for a number of reasons. Firstly, incorporation of the shaft 128 means that the motor 116 can be disposed in a different part of the print head 3 to that of the rest of sealing mechanism 124. This is desirable for reasons of not increasing the longitudinal extent of the print head 3 at the second end 102 by any more than is needed (e.g. to accommodate the volume of the motor). Increasing the longitudinal extent of the print head 3 at the second end 102 risks reducing a throw distance by which the print head 3 must be offset from a substrate to be printed. The use of the worm gear 130 is also advantageous for at least the reason that the gearing can effectively increase the torque output transmitted by the motor 116 to the rotatable body 122. This is particularly desirable where the rotatable body 122 may be partially stuck in position (e.g. stiction) following a cleaning process and a subsequent drying process. Described another way, the use of the worm gear 130 reduces the risk that the rotatable body 122 is stuck in position such that the drive assembly is unable to rotate the rotatable body 122 about the axis of rotation 126.

Returning to describe other components of the print head 3, coupled to the chassis 114 is a manifold 136. Various fluid and electrical connections extend through the manifold 136.

A nozzle housing 138 (shown in a partially cutaway view in FIG. 3) is coupled to the manifold 136 and houses a nozzle assembly 140. The nozzle housing 138 may otherwise be described as a body forming part of a housing. The nozzle assembly 140 comprises, among other components, a nozzle cradle 142 and a nozzle body 143. The nozzle body 143 defines a nozzle (not visible in FIG. 3) for generating and ejecting a stream of ink droplets for printing.

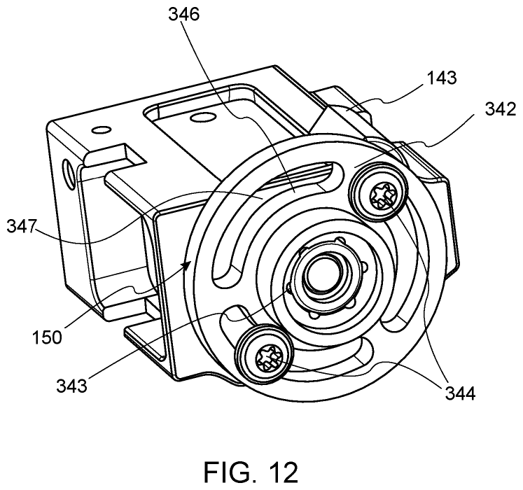

A charge electrode assembly 146 is coupled to the nozzle assembly 140. The charge electrode assembly 146 comprises a charge electrode 148 and an insulating coupling 150 to which the charge electrode 148 is coupled. As a stream of ink droplets is directed past the charge electrode 148 in use, they are selectively and separately given a predetermined level of charge by the charge electrode 148. In order to aid the alignment of the charge electrode 148 with respect to the stream of droplets emanating from the nozzle of the nozzle body 143, the charge electrode 148 is rotatably adjustable about axis. The adjustment mechanism is described in more detail with reference to FIG. 12 below. As will be appreciated from FIG. 3, the boot 151 is sandwiched between the charge electrode 148 and a chamber housing 162. The boot 151 allows the charge electrode 148 to remain sealingly engaged or sealingly coupled with the chamber housing 162 (see also FIG. 7/8) whilst the charge electrode 148 is adjusted.

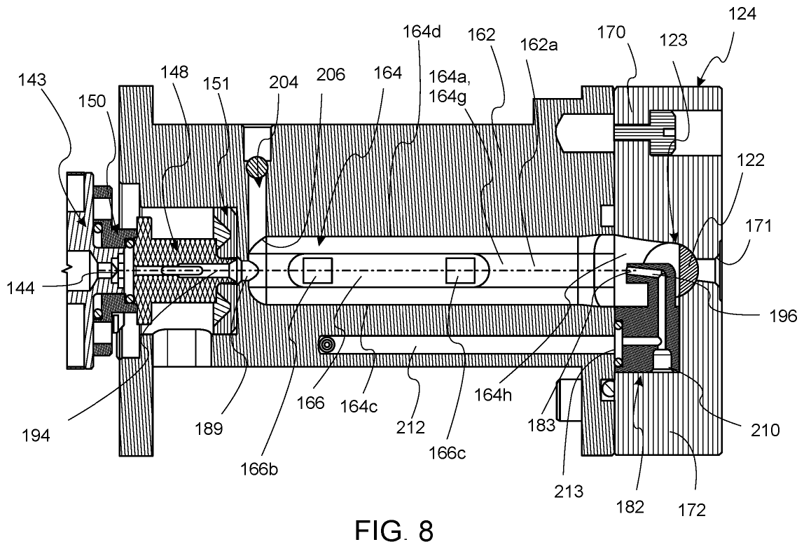

Returning to FIG. 3, coupled to the nozzle housing 138 is a chamber housing 162 (also shown partially cutaway in FIG. 3). The chamber housing 162 defines a chamber 164. The chamber 164 may otherwise be described as a washing cavity. Although further information in connection with the chamber 164 will be provided in the following Figures (the chamber 164 being visible in FIGS. 7 and 8 in particular), when the rotatable body 122 is in a second configuration in which the ink aperture 106 is closed, the chamber 164 is sealed for cleaning. Directing, or flushing a cleaning fluid into and through the chamber 164 when sealed thus cleans the chamber 164 and the associated components of the print head 3 which are provided in the chamber 164. Directing a cleaning fluid into the chamber 164 may comprise pumping the cleaning fluid (e.g. by action of an upstream pump, and under a positive pressure) and/or drawing the cleaning fluid (e.g. by action of a downstream pump, and under a negative pressure).

Coupled to the chamber housing 162, and mounted within the chamber 164, is a low voltage (e.g. grounded, or negative potential) electrode 166 and a deflection (e.g. high voltage) electrode 168. The electrodes 166, 168 may collectively be referred to as a pair of deflection electrodes. The low voltage electrode 166 may further comprise a phase detector which detects the phase of the charged particles in operation. The low voltage electrode 166 may be coupled to the chamber housing 162 by adhesive. In other embodiments the low voltage electrode 166 may be coupled to the chamber housing 162 by a gasket. The deflection electrode 168 is for guiding the stream of ink droplets, which are ejected by the nozzle and charged by the charge electrode 148, away from a gutter and towards the ink aperture 106 for printing onto a substrate in use. The deflection electrode 168 is disposed within the chamber 164 and can therefore be cleaned when the chamber 164 is sealed and the cleaning process is carried out.

The print head 3 further comprises a casing 170. The casing 170 forms part of the sealing mechanism 124. The casing 170 is coupled to the chamber housing 162. The casing 170 sealingly engages the chamber housing 162 by way of a gasket 173 which interposes the chamber housing 162 and the casing 170. The casing 170 may otherwise be described as a rotatable body mount, or housing. As will be described in detail later in this document, the rotatable body 122 is rotatably mounted within the casing 170 to selectively open and close the ink aperture 106. The casing 170 further comprises a cap 172 which is selectively detachable from the rest of the casing 170 to aid the installation and maintenance of the moving parts of the sealing mechanism 124 (e.g. the rotatable body 122). The casing 170 further comprises the end cap 104, which defines the ink aperture 106. The casing 170 may therefore be said to define the ink aperture 106. Although the ink aperture 106 is specifically defined by end cap 104 in the illustrated embodiment, in other embodiments the end cap 104 may be omitted. The casing 170 may therefore define the ink aperture even in the absence of an end cap. Also of note, the ink aperture 106 is downstream of the rotatable body 122 in the illustrated embodiment. That is to say, a stream of ink droplets first passes across the rotatable body 122 and then passes through the ink aperture 106. In other embodiments the rotatable body may define a downstream-most point of the ink path, such that there is no end cap positioned downstream of the rotatable body. In such embodiments the surrounding casing may be considered to define an ink aperture across the rotatable body.

For the avoidance of doubt, in the illustrated embodiment the end cap 104 is coupled to the chamber housing 162 and does not move in operation. That is to say, the end cap 104 is fixed in position. However, in other embodiments the end cap may define at least part of the rotatable body of the sealing mechanism. For example, the end cap may rotate, about an axis generally parallel to axis 129. The rotational position of the end cap may determine an extent to which an ink aperture of the end cap overlaps an ink aperture of an adjacent casing to ‘open’ the ink aperture of the adjacent casing. Where the ink apertures overlap at least partly, or entirely, the rotatable body (e.g. end cap) may be said to be in a first configuration in which an ink path is defined across the end cap. Where the ink aperture of the end cap does not overlap the ink aperture of the adjacent casing, the rotatable body (e.g. end cap) may said to be in a second configuration in which the ink aperture of the casing is closed.

Although shown in FIG. 3, various fasteners used to couple the chassis 114, the manifold 136, the nozzle housing 138, the chamber housing 162 and the casing 170 together are not annotated or described here in detail for brevity.

As will be appreciated from FIG. 7, the chamber 164 is defined by a combination of the chamber housing 162 and the casing 170. The chamber 164 has a lower surface defined by a combination of the low voltage electrode 166 (e.g. by surface 166a) and the surrounding chamber housing 162 (e.g. surface 162a), an upper surface which extends above the deflection electrode 168 (i.e. such that the deflection electrode 168 is disposed in the chamber 164) and is at least wide enough to contain the deflection electrode 168. Third and fourth surfaces 164c, 164d (which may be referred to as side surfaces) of the chamber 164 extend between the first and second surfaces 164a, 164b to define a perimeter of the chamber 164. The fourth surface 164d is not visible in FIG. 7.

With reference to FIG. 3, the print head 3 further comprises a PCB 167 which is mounted within the chamber housing 162. However, as indicated in FIG. 7, the PCB is not disposed within the chamber 164.

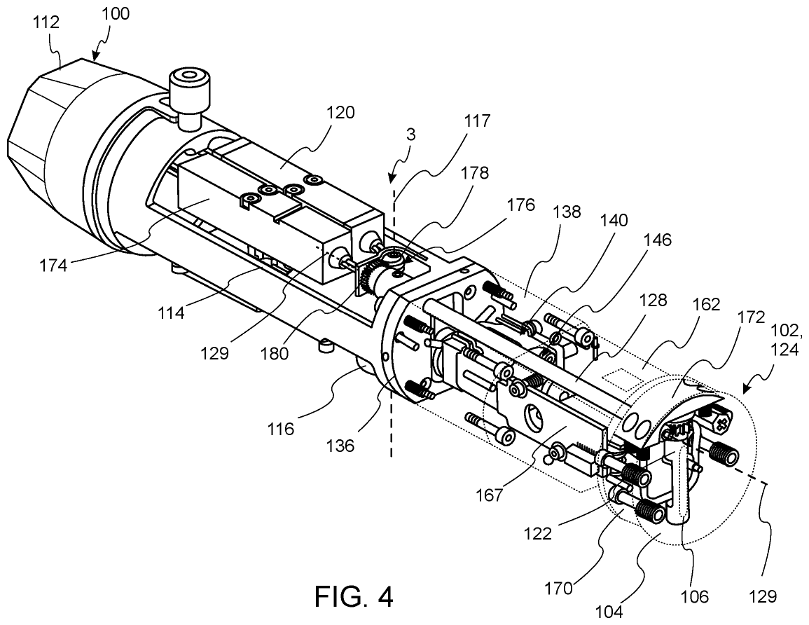

Turning to FIG. 4, an alternative perspective view of the print head 3 is provided. Owing to the different perspective, a number of components not visible, or only partially visible, in FIG. 3 are visible in FIG. 4.

Beginning from the first end 100 of the print head 3, the connector 112 and integral chassis 114 are shown. The solenoid valve 120 is shown mounted to the chassis 114, along with a valve block 174. Also visible in FIG. 4 is a worm gear 176 comprising a worm 178 and a gear 180. The worm 178 is rotatably coupled to the motor 116 which is just visible at the opposing side of the chassis 114 as shown in FIG. 4 (and is more clearly visible in FIG. 3). The worm 178 is driven to rotate about the axis of rotation 117. The worm 178 is provided in driving communication with the gear 180, the gear 180 being rotatably coupled to the shaft 128. The gear 180 and shaft 128 are thus driven to rotate about the axis of rotation 129, which may be referred to as a shaft axis. It will be appreciated that by use of the worm gear 176, the direction of rotation as driven by the motor 116 is effectively translated through 90°which is advantageous for reasons of space constraints within the print head 3. The shaft 128 is shown extending across an entire extent of each of the manifold 136, nozzle housing 138, chamber housing 162 and partially through the casing 170.

As described in connection with FIG. 3, also coupled to the chassis 114 are manifold 136, nozzle housing 138, chamber housing 162 and casing 170. The PCB 167 is also visible in FIG. 4. The nozzle assembly 140, coupled to the nozzle housing 138, and the charge electrode assembly 146 are also partially visible in FIG. 4.

Turning briefly to the sealing mechanism 124 at the second end 102 of the print head 3, as previously described the sealing mechanism 124 comprises the casing 170 (which comprises cap 172 and end cap 104) and the rotatable body 122. The ink aperture 106, defined by the casing 170, is also visible.

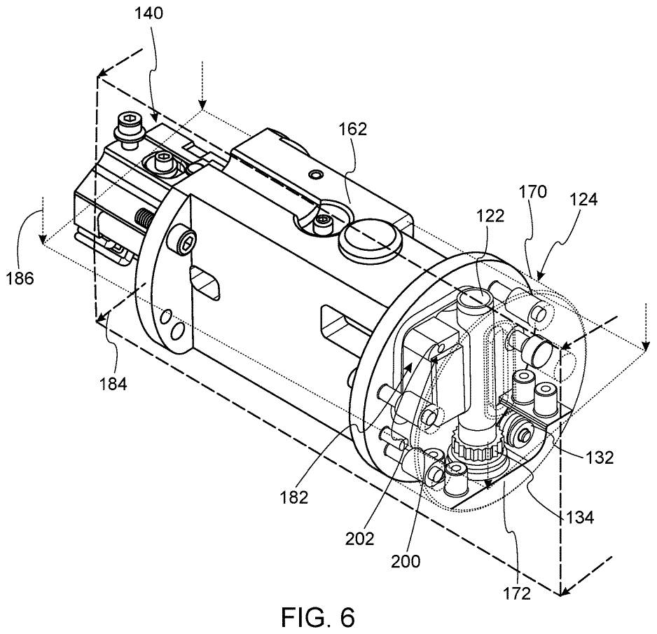

Of note, a component that has not yet been described in detail in connection with the print head 3 is that of a gutter. The print head 3 does incorporate a gutter which, in the illustrated embodiment, is a fixed gutter coupled to the casing 170. Details of the gutter will be provided in connection with FIG. 6 onwards.

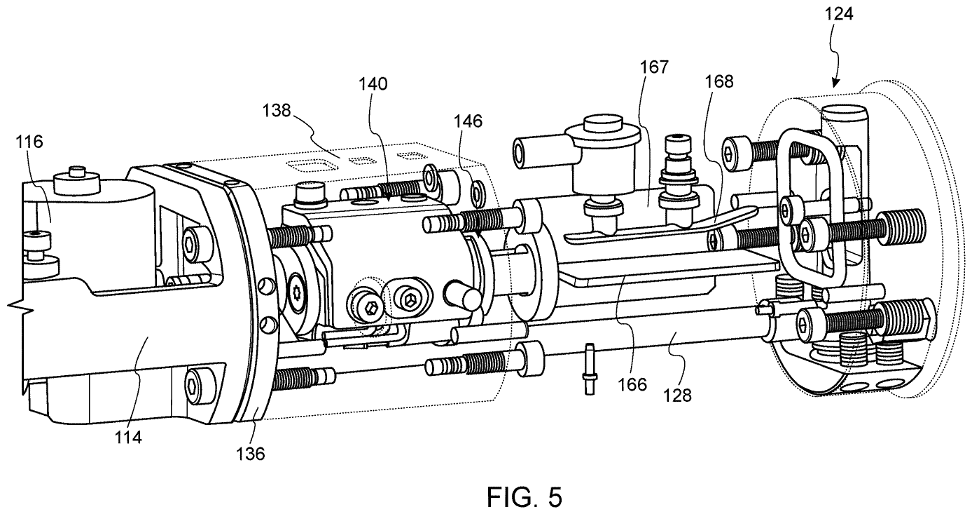

Turning to FIG. 5, a magnified perspective view of part of the print head 3 is provided. As will be appreciated from FIG. 5, the motor 116 is partially visible, as is the chassis 114, but any components further towards the first/connector end of the print head 3 are not visible. Similarly, the chamber housing 162 as shown in FIGS. 3 and 4 is not shown in FIG. 5 to aid visibility of the components housed therein.

FIG. 5 shows the geometry of the deflection electrode 168 which is used to guide a stream of ink droplets towards a substrate to be printed.

FIG. 6 is a perspective view of a subassembly of the print head 3. FIG. 6 shows the chamber housing 162 with the nozzle assembly 140 and sealing mechanism 124 coupled thereto.

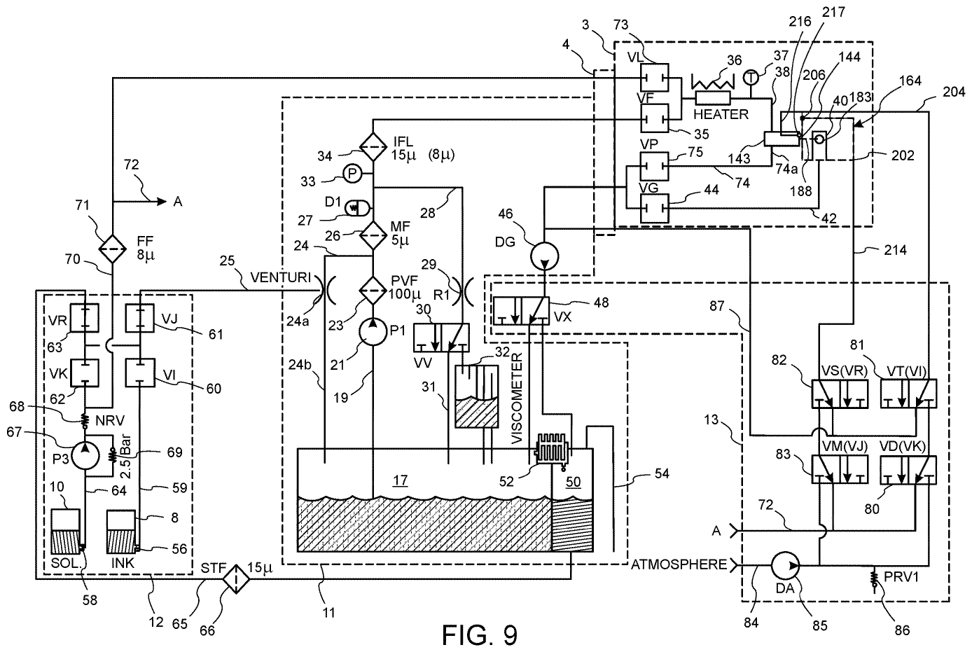

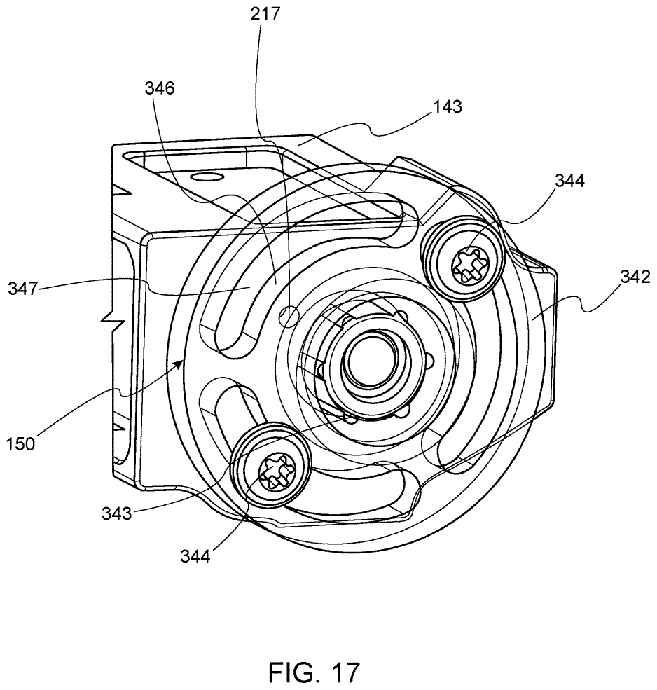

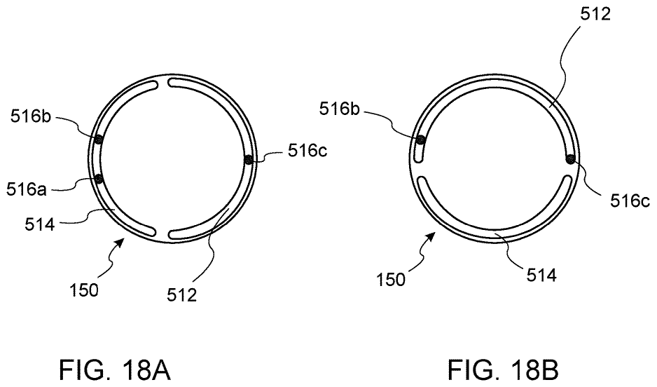

As previously described, various components of the sealing mechanism 124 are visible including the rotatable body 122, the casing 170, including the cap 172, and the worm 132 and gear 134. Also visible in FIG. 6 is gutter block 182. The gutter block 182 will be described in greater detail in connection with later Figures, but briefly the gutter block 182 comprises a gutter aperture (not visible in FIG. 6) through which droplets of ink which are not used for printing are received and subsequently recirculated back to a mixer tank of the ink system (as will be described in detail in connection with FIG. 9). In the illustrated embodiment the gutter block 182 is a separate component to that of the surrounding casing 170 and other components. However, in some embodiments the gutter may be integral with the rotatable body (e.g. see FIGS. 17, 18).

The gutter block 182 further comprises a recess 200 defined in an effective underside of the gutter block 182. The recess 200 leads into a port 202. The port 202, in turn, defines a second conduit (e.g. 214 as shown in FIG. 9). Owing to the presence of the recess 200, the second conduit is still provided in fluid communication with the chamber even when the rotatable body 122 is in the second, closed configuration as shown in FIG. 6. Cleaning fluid can therefore be pumped or drawn into the chamber via the second conduit, or used (e.g. dirty) cleaning fluid be pumped or drawn out of the chamber via the second conduit. Further detail in this regard will be provided below.

Also schematically indicated on FIG. 6 are first and second cross-sectional markers 184, 186. 184 is a vertical cross-section and 186 is a horizontal cross-section. The markers 184, 186 correspond to the cross-section views provided in FIGS. 7 and 8 respectively.

Turning to FIG. 7, a cross-section side view of the subassembly shown in FIG. 6 is provided as indicated by annotation 184 in FIG. 6. FIG. 7 shows the chamber 164 which can be selectively sealed by the sealing mechanism 124.

Beginning from the right hand end of FIG. 7, only part of the nozzle body 143 of the nozzle assembly 140 is visible. Nozzle body 143 retains a nozzle 144 that generates and ejects a stream of ink droplets 188 for printing. Downstream of the nozzle 144 is the charge electrode 148. The charge electrode 148 is coupled to the insulating coupling 150. In the illustrated embodiment the charge electrode 148 is rotatably coupled to the insulating coupling 150 by fasteners 147, 149. The insulating coupling 150 (and so the charge electrode 148) is rotatably adjustable with respect to the nozzle body 143. The insulating coupling 150 is an insulator (which may be plastic) which separates the charge electrode 148 from the nozzle body 143 (which is grounded). The charge electrode 148 abuts the boot 151 such that the boot 151 is sandwiched between the charge electrode 148 and the chamber housing 162. The boot 151 also facilitates adjustment of the charge electrode 148 with respect to the chamber housing 162 by allowing a degree of movement of the charge electrode 148 with respect to the chamber housing 162.

The charge electrode 148 is provided in communication with the chamber 164 by a channel 189. In use, as indicated in FIG. 7, a stream of ink droplets 188 is generated and ejected by the nozzle 144 and travel through the chamber 164 via the charge electrode 148 and the first channel 189. Having passed through the charge electrode 148 the stream of ink droplets 188 has a charge applied to them. The selectively charged stream of ink droplets 188 can be selectively deflected by the deflection electrode 168 for printing. A stream of ink droplets which has been deflected for printing by the deflection electrode 168 is labelled 190 in FIG. 7. A stream of ink droplets which are not used for printing, and which have therefore not been deflected by the deflection electrode 168, is labelled 194. The stream of ink droplets 194 not used for printing are received by a gutter aperture 183 of the gutter block 182. Part of a gutter conduit 196, defined by the gutter aperture 183, is also visible in FIG. 7. This is the conduit through which the droplets of ink 194 which are not used for printing, and which are received by the gutter aperture 183, travel.

For completeness, in FIG. 7 the rotatable body 122 of the sealing mechanism 124 is shown in the second, closed configuration. As such, none of the streams of ink droplets 188, 190, 194 would be present when the sealing mechanism 124 is in the configuration shown in FIG. 7. FIG. 7 indicates that the gutter block 182 is at least partially received by the casing 170 and, although not visible in FIG. 7, the chamber 164 also extends behind the gutter block 182 as shown in FIG. 7 (e.g. into the plane of the page). This is, however, visible in FIG. 8 and will be described in connection with the same.

Returning to FIG. 7, the sealing mechanism 124 comprising the rotatable body 122 rotatably coupled to the gear 134 is also shown. A shaft 198 of the rotatable body 122 is also visible. It is about the shaft 198 that the rotatable body 122 rotates about the axis of rotation 126 in use. The shaft 198 is received by a recess 199 of the cap 172 to constrain and locate the rotatable body 122.

An ink aperture 171 defined by the casing 170 is also visible in FIG. 7. The rotatable body 122 effectively closes the ink aperture 171 in the configuration shown in FIG. 7. In a first, open configuration, in which the rotatable body 122 is rotated relative to the position shown in FIG. 7, the ink aperture 171 is effectively opened such that the stream of ink droplets 190 can pass across the rotatable body 122, through the ink aperture 171, via an ink path 190. As the stream of ink droplets 188 passes across the chamber 164, the phase detector forming part of the low voltage electrode 166 also operates to detect the phase of the ink particles. Of note, as shown in FIG. 2 the end cap 104 defines the ink aperture 106. The ink aperture 171 shown in FIG. 7 overlaps the ink aperture 106 defined by the end cap 104, and the ink aperture 106 can therefore also be considered to be opened/closed by the rotatable body 104 (at least by virtue of being downstream of the ink aperture 171).

Finally, also shown in FIG. 7 is the recess 200 defined in the gutter block 182. As described in connection with FIG. 6, the recess 200 partly defines the port 202 which is used for cleaning and draining.

Turning to FIG. 8, an alternative cross-section view to that shown in FIG. 7 is provided. In FIG. 8 the subassembly of FIGS. 6 and 7 is shown by way of a cross-section view as indicated by the annotations 186 in FIG. 6. FIG. 8 may therefore be described as a cross-section plan view of the subassembly.

As described in connection with FIG. 7, FIG. 8 also shows the nozzle body 143, insulating coupling 150, charge electrode 148 and boot 151. FIG. 8 also shows the low voltage electrode 166 being located within the chamber 164. Also visible in FIG. 8 is a phase detector electrode 166b (which may be referred to as a phase pickup electrode) and a velocity detector electrode 166c. The electrodes 166b, 166c (and low voltage electrode 166) are etched into the PCB (e.g. a rear of the PCB, in the illustrated embodiment) which defines the low voltage electrode 166. The combination of the electrodes 166, 166b, 166c may be referred to as a phase detector assembly. The phase detector electrode 166b is configured to determine a magnitude of charge applied to the droplets of ink as they move past the phase detector electrode 166b. Measurements from the phase detector electrode 166b are used to determine when to apply a voltage to the charge electrode 148. The velocity detector electrode 166c is configured to determine the velocity of the droplets of ink as they move past the electrode 166b. The velocity is determined by measuring the time between the charge ‘pulse’ being detected by the phase detector electrode 166b and subsequently by the velocity detector electrode 166c, and dividing the distance between the electrodes 166b, 166c by that time. The low voltage electrode 166 takes the form of an Electroless Nickel Immersion Gold (ENIG) coated copper ground plate in the illustrated embodiment. The low voltage electrode 166 acts as the 0V plate for the deflection electrode, which establishes the EHT field that deflects the stream of ink droplets in use. The phase detector electrode 166b and velocity detector electrode 166c are covered by an insulator (e.g. a solder resist in the illustrated embodiment). This prevents ink and/or solvent shorting the electrodes 166b, 166c to the low voltage electrode 166.

Owing to each of the: phase detector electrode 166b, velocity detector electrode 166c, low voltage electrode 166 and deflection electrode 168 (not shown in FIG. 8) being disposed in the chamber 164, all of these components can be cleaned during a cleaning cycle. Similarly, the charge electrode 148, although located outside of the chamber 164, can also be cleaned in a cleaning cycle by virtue of a third port or charge electrode drain port (not visible in FIG. 8, but will be described in detail below).

FIG. 8 does show that in the illustrated embodiment the chamber 164 comprises first and second chamber portions 164g, 164h. The first chamber portion 164g is defined by the chamber housing 162. The second chamber portion 164h is defined by the casing 170. As such, the chamber 164 may be said to be at least partially defined by the casing 170 in the illustrated embodiment. In other embodiments it will be appreciated that the chamber housing 162 could be integral with the casing 170 such that the chamber 164 be defined entirely by the casing 170.

FIG. 8 also shows the chamber housing 162 comprises a (first) conduit 204 which extends partly through the chamber housing 162 and is in communication with the chamber 164 via a port 206. The port 206 may therefore be said to at least partly define the chamber 164. The conduit 204 is multipurpose in that it can be used to either supply the chamber 164 with cleaning fluid or to drain used cleaning fluid from the chamber 164. The conduit 204 may therefore be described as a chamber cleaning and draining channel. The conduit 204 may specifically be described as an upstream chamber cleaning/draining channel, owing to it being disposed proximate the channel 190 through which ink droplets are ejected into the chamber 164.

FIG. 8 also shows more features of the gutter block 182. As mentioned in connection with FIG. 7, the gutter block 182 comprises the gutter aperture 183 through which ink droplets which are not to be used for printing are received/collected. The gutter aperture 183 defines an upstream end of the gutter conduit 196 which extends through the gutter block 182. At a point downstream, the gutter conduit 196 appears to branch off to a recess 210. The recess 210 is sealed in use, and is only to facilitate manufacture of the gutter conduit 196 through the gutter block 182. Further downstream of the gutter conduit 196 is a return conduit 212 defined at least partly by the chamber housing 162. The return conduit 212 is provided in fluid communication with the gutter conduit 196, and so the gutter aperture 183. Ink droplets which are not used for printing are thus received by the gutter aperture 183 and are drawn through the gutter conduit 196 and the return conduit 212 by suction. The unused ink droplets are then returned to the mixer tank. For completeness, the gutter block 182 is sealed against the chamber housing 162 by seal 213.

In the illustrated embodiment the gutter block 182 forms a separate component which is fixedly coupled to the chamber housing 162. In other embodiments (e.g. FIGS. 17, 18), at least part of the gutter may rotatably coupled to the rotatable body 122, and may be integral with the rotatable body 122. Partially shown in FIG. 8 is a recess 123 of the rotatable body 122.

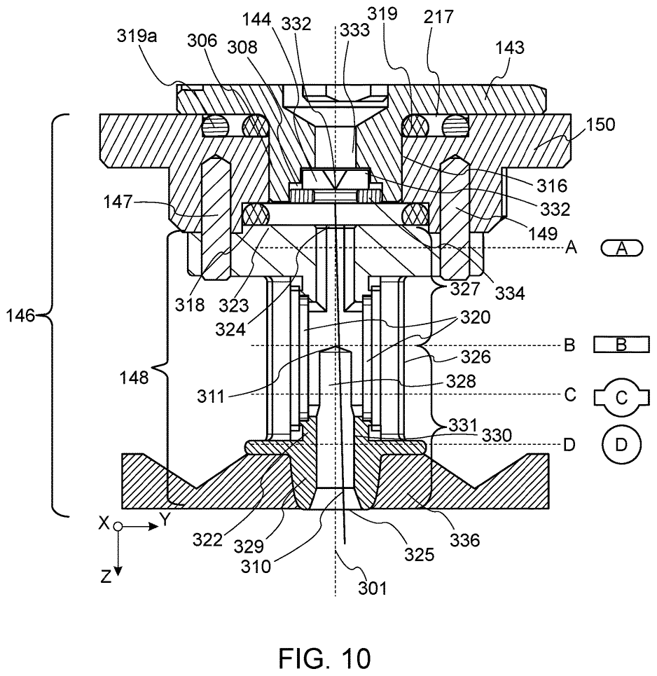

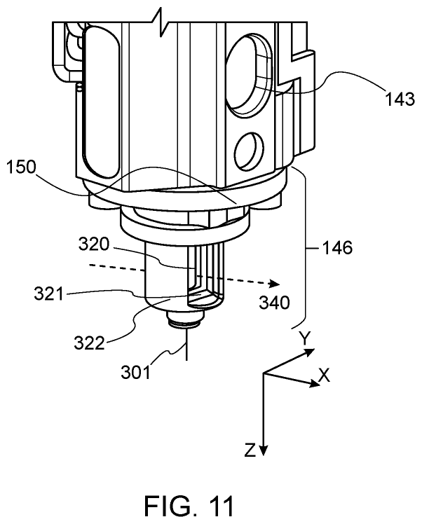

When the rotatable body 122 is in the second configuration as shown in FIG. 8, in which the rotatable body 122 closes the ink aperture 171, the gutter block 182 is partially received by a recess 123 of the rotatable body 122. When the rotatable body 122 is in a first configuration, in which an ink path is defined across the rotatable body 122 and through the ink aperture 171, the rotatable body 122 is effectively rotated counter clockwise by around 90°such that the gutter block 182 is still partially received by the recess 123 but in a different orientation. This will be described in greater detail in connection with FIGS. 10 and 11.

Referring now to FIG. 9, a schematic diagram of a fluid system for the printer of FIG. 1, incorporating the print head 3, is shown. The ink jet printer 1 comprises the ink system 5 which is contained within the main printer body 2. The ink system 5 comprises at least the components that form part of a main ink block 11. The ink system may further comprise a cartridge module 12 and a cleaning module 13. Components of the print head are schematically indicated 3.

Beginning with the main ink block 11, the main ink block 11 comprises a mixer tank 17 (which may also be referred to as an ink feed, or ink supply, tank) configured to supply ink along a main supply line 19. The ink is drawn from the mixer tank 17 by an ink pump 21. Ink also passes through a first filter 23, downstream of the ink pump 21, disposed along the main supply line 19. The first filter 23 removes any particles (e.g. sediment) contained within the mixer tank 17. The first filter 23 is a 100 micron filter in the illustrated embodiment, but it will be appreciated other sizes of filter could otherwise be used. A Venturi line 24 is connected to the main supply line 19 downstream of the first filter 23. Provided along the Venturi line 24 is a Venturi 24a (e.g. a restriction). In operation, fluid (e.g. an ink mixture) is continuously circulated from the mixer tank 17, through the main supply line 19, through the Venturi line 24, and so through the Venturi 24a, before being returned to the mixer tank 17. This continuous circulation, combined with the Venturi 24a, creates suction to draw fluids into the mixer tank 17 via a refill line 25, which extends between the cartridge module 12 and the Venturi 24a. Fluids are drawn into the mixer tank 17 through the Venturi 24a and a downstream portion 24b of the Venturi line 24.

The ink pump 21 may be operated as a pressure controlled pump, meaning that the ink flow rate through the pump 21 will be adapted as necessary to maintain a target pressure downstream of the ink pump 21 (e.g. as monitored by a pressure sensor 33). The ink pump 21 may be configured to supply ink to the print head 3 at a predetermined system operating pressure, which may be determined based upon the printer configuration (e.g. nozzle geometry). For example, a nozzle having a diameter of 75 μm may require a lower operating pressure than a nozzle having a diameter of 62 μm to achieve a similar jetting performance (e.g. ink droplet breakup location, or flight time to breakup). The system operating pressure may also be varied in dependence upon other system parameters (e.g. ink type, viscosity).

A second filter 26, having a filtration size of 5 microns, is provided downstream of the first filter 23 along the main supply line 19. A damper 27 is provided downstream of the ink pump 21, and downstream of the second filter 26, to reduce fluctuations in ink pressure within the ink supply. Downstream of the damper 27, a load line 28 branches off the main supply line 19. The load line 28 comprises a restriction 29. The load line 28 is configured to maintain a near-constant load on the main supply line 19, avoiding pressure spikes in the print head 3 due to load spikes of the ink pump 21 (e.g. due to activation of the ink pump 21). A viscometer valve 30 is disposed along the load line 28. The viscometer valve 30 can selectively place the load line 28 in fluid communication with either the mixer tank 17, via a tank line 31, or a viscometer 32. The viscometer valve's 30 default configuration is to place the load line 28 in fluid communication with the mixer tank 17. This creates a circular fluid flow path. When it is desired to ascertain the viscosity of the ink mixture in the main supply line 19, and so the load line 28, the viscometer valve 30 is energised to direct the flow into the viscometer 32. Initially the viscometer 32 is empty. By monitoring the time taken to fill and/or empty the viscometer 32, and based upon a known volume of fluid in the viscometer 32, the viscosity of the ink mixture can be ascertained.

Downstream of the damper 27 and the load line 28, a pressure sensor 33 is connected to the main supply line 19 and is configured to monitor the pressure downstream of the ink pump 21. The ink pump 21 may be operated as a constant pressure pump (i.e. the pump is controlled to maintain a constant output pressure). A third filter 34, having a filtration size of 15 microns, is provided downstream of the pressure sensor 33.

The main supply line 19 is configured to carry ink from the ink mixer tank 17, along the umbilical 4, to the print head 3. The main supply line 19 is connected to the print head 3 via a feed valve 35. The feed valve 35 is configured to control the ink supply to the print head 3. Downstream of the feed valve 35 a heater 36 is provided. The heater 36 is used to control the temperature of the ink mixture. Controlling the temperature of the ink mixture reduces the effect that temperature fluctuations could otherwise have on the viscosity of the ink mixture. For example, activation of the heater 36 provides a heating effect which reduces the viscosity of the ink mixture. A temperature sensor 37 is provided downstream of the heater 36. The heater 36 is provided in fluid communication with the nozzle body 143, and so nozzle 144, via a nozzle line 38. The heater 36 preferably maintains the ink mixture at a temperature of at least around 308° K (e.g. ~35° C.).

As described above, ink is fed along the main supply line 19 to the print head 3 via the umbilical 4. Within the print head 3 the ink is provided to the nozzle 144. The ink is provided to the nozzle 144 under pressure (under the influence of the ink pump 21) and forms an ink jet. The ink jet begins as a constant stream of ink and, under the influence of surface tension and vibrations applied in the nozzle body 143 (e.g. by a piezoelectric oscillator), gradually separates into a series of ink droplets 188 which continue to travel in the direction of the ink jet 57.

Shortly after emerging from the nozzle 144 of the nozzle body 143, the ink jet is passed through a charge electrode (not shown in FIG. 9, but labelled 148 in FIG. 3). The point at which the continuous ink jet separates into droplets 188 is arranged to occur within the charge electrode. The ink is an electrically conductive liquid, and the nozzle body 143 is conventionally held at a fixed (e.g. ground) potential. A variable voltage is applied to the charge electrode (not shown in FIG. 9 but labelled 148 in FIG. 3) causing charge to be induced on the continuous stream of ink droplets extending from the nozzle body 143 towards the charge electrode. As the continuous stream of ink (i.e. ink jet) separates into droplets 188, any charge induced on the ink within the droplet becomes trapped at the moment the individual droplet “snaps” off from the main stream of ink. In this way, a variable charge can be applied to each of the ink droplets within in the stream of ink droplets 188.

The stream of ink droplets 188 then continues to pass from the charge electrode between further electrodes (not shown in FIG. 9, but labelled 166, 168 in FIG. 3). A first electrode (e.g. a low voltage electrode) is held at a first voltage, whereas the second electrode (e.g. deflection electrode) is held at second voltage, with a large potential difference (e.g. 8-10 kilovolts) established between the electrodes. In some systems, one electrode may be maintained at a ground potential while the other electrode is held at a high (positive or negative) voltage (with respect to ground). In other systems, one electrode is held at a negative voltage (with respect to ground) and the other electrode is held at a positive voltage (with respect to ground). The electric field established between the electrodes causes any charged droplets (i.e. those that have been charged by the charge electrode) to be deflected. In this way, based upon the variable charge applied by charge electrode, the droplets 188 can be selectively (and variably) steered from the path along which they are emitted from the nozzle 144.

Droplets which pass through the deflection field and which are deflected by the electrodes are not shown in FIG. 9, but are labelled 190 in FIG. 7. The stream of droplets 190 are used for printing. The stream of ink droplets 190 may be described as defining an ink path across the rotatable body (of the sealing mechanism) and through the ink aperture.

Returning to FIG. 9, droplets which pass through the deflection field without being deflected (i.e. droplets which are not used for printing) travel to a gutter 40 (e.g. the gutter block 182 of the earlier Figures). The gutter 40 comprises an orifice 183 (e.g. gutter aperture 183 of the earlier Figures) into which the droplets enter. The gutter 40 is connected to a gutter line 42 which extends from the gutter 40 back to the main ink block 11 (e.g. the gutter line 42 extends between at least the gutter 40 and the gutter pump 46). A gutter valve 44 is optionally provided within the gutter line 42 enabling the gutter line 42 to be opened and closed. A suction force is applied to the gutter line 42 by a gutter pump 46 to draw ink along the line from the gutter 40 back towards the main ink block 11. In other embodiments the suction may be provided by a Venturi in communication with the ink pump 21.

Downstream of the gutter pump 46 a tank valve 48 is provided. The tank valve 48 selectively places the gutter pump 46 in fluid communication with either the mixer tank 17 or a solvent tank 50 (which may be described as a ‘used’ solvent reservoir). In the illustrated embodiment, the solvent tank 50 is provided adjacent the mixer tank 17. The solvent tank 40 and mixer tank 17 are shown as different compartments within an overall tank in the illustrated embodiment, but in other embodiments the mixer and solvent tanks 17, 40 could be physically separate tanks. During printing operations, the tank valve 48 places the gutter pump 46 in fluid communication with the mixer tank 17. The ink mixture (e.g. the stream of ink droplets 188) received by the gutter 40 is thus returned to the mixer tank 17 and can be recirculated/reused at a later time. During non-printing operations (e.g. such as priming, cleaning operations etc.), the tank valve 48 may place the gutter pump 46 in fluid communication with the solvent tank 50. This is to avoid cleaning fluid, such as ‘used’ solvent, undesirably contaminating (e.g. altering the viscosity of) the ink mixture in the mixer tank 17.

In addition to unprinted droplets of ink being recirculated via the gutter 40, any air which is sucked into the gutter 40 will also be delivered to the mixer tank 17 or solvent tank 50. The mixer tank 17 and solvent tank 50 are in communication with one another via a condenser 52 (which also acts as a vent). Solvent in the ink mixture in the mixer tank 17 tends to evaporate as solvent vapour in the mixer tank 17. Saturated solvent vapour is therefore present in the mixer tank 17 during use. As said vapour passes over the condenser 52, the comparatively cool surfaces of the condenser 52 result in the solvent, contained in the vapour, condensing. The solvent vapour thus returns to liquid, and is deposited back into the solvent tank 50. This advantageously avoids undue loss of solvent from within the system (which would otherwise occur if both tanks were vented directly to atmosphere). Furthermore, the mixer tank 17 is effectively vented by the condenser 52, preventing excess pressure building up within the mixer tank 17. Gases vented from the mixer tank 17 thus travel into the solvent tank 50. In turn, the solvent tank 50 is vented by a solvent tank vent line 54 provided in fluid communication with the solvent tank 50. Through solvent tank vent line 54 gases can be vented, preferably to outside of the printer cabinet (in which the ink system is contained).

The ink system, specifically the cartridge module 12 thereof, comprises an ink cartridge connection 56 which may be connected to the associated ink cartridge 8 and a solvent cartridge connection 58 which may be connected to the associated solvent cartridge 10. The ink cartridge 56 and ink cartridge connection 58 are connected to the refill line 25, allowing ink or solvent to be drawn, by the Venturi line 24, into the mixer tank 17. In other embodiments, a dedicated transfer pump may be used instead of the Venturi line 24.

By using a Venturi in this way (i.e. as a jet pump), a system can be designed in which the main system ink pump 21 can generate both positive pressures (e.g. to supply ink to the print head 3) and negative vacuum pressure (e.g. to draw ink or solvent into the mixer tank 17 via the refill line 25).

The feed valve 27, provided along main supply line 19, is configured to prevent the main supply line 19 from being continuously open. However, since the feed valve 27 is provided downstream of the Venturi line 24, even when the feed valve 27 is closed, when the ink pump 21 is operating, a flow of ink will flow along Venturi line 24 through the Venturi 24a, resulting in suction being applied to the refill line 25. In this way, the suction can be applied even when ink is not being supplied to the print head 3. Of course, a second valve 61 may also be operated to block the refill line 25, meaning that the refill line suction can be controlled independently of the Venturi 24a.

It will be appreciated that by selectively activating one or more of four cartridge valves 60, 61, 62, 63, the ink cartridge 56 can be placed in fluid communication with the refill line 25. For example, opening only first and second valves 60, 61 (and closing third and fourth valves 62, 63) places the ink cartridge 8 in fluid communication with the refill line 25 via an ink refill line 59. Ink can thus be drawn into the mixer tank 17, via the ink refill line 59 and refill line 25, to add ink to the mixer tank 17.

Solvent can be directed to the solvent tank 50, directly from the solvent cartridge 58, by the solvent refill line 64 and a solvent tank line 65. Closing the first and second valves 60, 61, and opening third and fourth valves 62, 63, places the solvent cartridge 10 in fluid communication with the solvent tank 50 via the solvent tank line 65 and the solvent refill line 64. Solvent can also be drawn from the solvent tank 50, through the solvent tank line 65 and into the cleaning module inlet line 72 (which will be described below). A solvent tank refill line filter 66 is provided along the solvent tank refill line 64. A solvent pump 67 is provided downstream of the solvent cartridge 10 along the solvent refill line 64. Activation of the solvent pump 67 can be used to pump solvent from the solvent cartridge 10 into the solvent tank 50. Advantageously, the amount of solvent added to the solvent tank 50 can be measured by determining the fluid level within the solvent tank 50. This volume can then be subtracted from a remaining solvent cartridge volume held on a smart chip on the solvent cartridge 10. The remaining volume of solvent in the solvent cartridge 10 can thus be ascertained. This has been found to be more accurate than measuring the volume of solvent drawn out of the solvent cartridge 10 under a negative pressure (owing to the vacuum level within a cartridge generally changing as the cartridge is evacuated of fluid). In the illustrated embodiment, solvent is pumped out of the solvent cartridge 10 under action of the solvent pump 67.

When it is desired to add solvent to the mixer tank 17, second and fourth valves 61, 63 are opened, and first and third valves 60, 62 closed. Solvent is then drawn from the solvent reservoir 50, via solvent tank line 65 and refill line 25, by Venturi 24a, into the mixer tank 17.

Activation of the solvent pump 67 can also be used to pump solvent from the solvent cartridge 10, along the solvent refill line 64, for some non-printing operations, such as priming the fluid circuit. This will be described below. The solvent pump 67 is not used to actively pump pressurised cleaning fluid (e.g. solvent) into the chamber 164, via the cleaning module inlet line 72, for cleaning in the illustrated embodiment. Instead, cleaning fluid is preferably drawn into the chamber 164 under vacuum for cleaning. This provides failsafe operation, should the sealing mechanism fail, in that the cleaning fluid will just not be drawn into the chamber 164. Were the cleaning fluid pumped into the chamber 164 under pressure (e.g. under action of an upstream pump), failure of the sealing mechanism risks cleaning fluid being ejected from the print head 3 (e.g. via the ink aperture) onto the printing line. This risks undesirable contamination. That said, cleaning fluid could equally be pumped into the chamber in some embodiments.

A non-return valve 68 is provided downstream of the solvent pump 66, along the solvent refill line 64, to prevent fluid travelling past the non-return valve 68 towards the solvent pump 66. A further non-return valve 69 is provided in a branch line which extends around the solvent pump 67. The non-return valve 69 is an overpressure valve for the solvent pump 67. The non-return valve 69 is a pressure relief valve which determines a maximum solvent pressure from the solvent pump 67. For completeness, the cartridge valves 60-63 can also be selectively activated to provide other configurations for, for example, priming of the fluid system and for draining the mixer tank 17 and/or solvent tank 50 (e.g. during maintenance).

A flush line 70 is connected between the third valve 62 and the non-return valve 68. the flush line 70 directly connects the cartridge module 12 to the print head 3 via the umbilical 4. A flush filter 71 is provided along the flush line 70, upstream of a cleaning module inlet line 72 which branches off the flush line 70. The flush line 70 extends to the print head 3 via a flush valve 73 disposed along the flush line 70. The flush line 70 is used to route solvent from the solvent cartridge 58 into the nozzle body 143. Solvent can thus be forced through the nozzle 144 to clean the nozzle. This is by way of activating the solvent pump 67, which provides pressurised solvent to the nozzle 144 for nozzle cleaning. The flush valve 73 is closed by default (e.g. during printing operations) and is only opened during non-printing operations (e.g. priming). Solvent can be prevented from being pumped into the chamber 164 via the cleaning module inlet line 72 by selective activation of valves in the cleaning module 13. Put another way, the cleaning module inlet line 72 can effectively be closed, so that solvent flows through the flush line 70 to the flush valve 73, by selective activation of valves in the cleaning module 13.

A purge line 74 is connected to the nozzle body 143. The purge line 74 is connected to a purge port 74a of the nozzle body 143. The nozzle body 143 may be provided as part of a nozzle assembly, which includes the nozzle body 143 having known acoustic properties, and a piezoelectric oscillator. The purge port may be provided by the body, or by a separate part connected to the body. The purge line 74 allows ink (and/or air and/or debris) to flow (or pass) out of the nozzle body 143 via a purge aperture 74a (e.g. a purge port) without passing through the nozzle 144, and allows the nozzle body 143 to be cleaned. The purge line 74 extends from the nozzle body 143, along the umbilical 4, and returns ink (or solvent), depending upon the phase of operation, to the mixer tank 17. The purge line 74 is provided in selective fluid communication with the gutter pump 46, via purge valve 75. Fluid is drawn through the purge line 74 by suction of the downstream gutter pump 46. A purge valve 75 is provided along the purge line 74. It will be understood that the purge line is not essential, and may be omitted in some printers. The incorporation of the purge line 74 is advantageous for a number of reasons. The purge line 74 can be used to remove air from the nozzle body 143 (e.g. from within a chamber of the nozzle body 143). Removal of air from the nozzle body 143 is desirable because the presence of air can negatively impact the acoustic performance of the nozzle body 143. The purge line 74 can also be used to remove debris that may become trapped in the nozzle chamber when a backflush is carried out. A backflush refers to a process in which solvent is applied to a front face of the nozzle 144 whilst a vacuum is generated in the nozzle body. The purge line 74 also allows ink to be removed/drained from the interior of the nozzle body 144, and the interior of the nozzle body 144 washed, more effectively.

The main supply line 19, purge line 74, gutter line 42, and flush line 70 thus connect the ink system (e.g. the main ink block 11 and cartridge block 12) to the print head 3. Additional fluid connections housed within the umbilical 4 may connect the ink system 5 to the print head 3. For example, an air recirculation line may be provided to provide solvent saturated air to the gutter line 42 close to the gutter entrance.

The chamber 164 is also schematically indicated in FIG. 9. As indicated in FIG. 9, the gutter 40 is disposed in the chamber 164 in the illustrated embodiment. The nozzle body 143 is outside of the chamber 164 in the illustrated embodiment. Two conduits 204, 214 are shown connected to the chamber 164. The first conduit 204 is also shown in FIG. 8. The first conduit 204 is in fluid communication with the chamber 164 via the first port 206. The first port 206 is disposed proximate the charge electrode and nozzle body 144 (e.g. at an upstream location within the chamber 164). The second conduit 214 is in fluid communication with the chamber 164 via the second port 202. The second port 202 is disposed proximate the gutter 40 (e.g. the gutter block 183 in FIG. 6). The second port 202 is disposed at a downstream location within the chamber 164. The first and second conduits 204, 214, and so first and second ports 206, 202, can be used to supply the chamber 164 with cleaning fluid or to drain used cleaning fluid from the chamber 164. Each of the first and second conduits 204, 214 can be selectively opened/closed by action of corresponding valves of the cleaning module 13.

Also shown in FIG. 9 is a third conduit 216 which extends from the second conduit 214 to, and partway through, the nozzle body 143. The third conduit 216 may therefore be described as a branch of the second conduit 214. The third conduit 216 terminates at a third port 217. The third port 217 is defined in a front face of the nozzle body 143. The third conduit 216 and third port 217 are optional features of the illustrated embodiment, and may be omitted in other embodiments. The third conduit 216, and corresponding third port 217, is used to supply at least part of the charge electrode, and so downstream chamber, with cleaning fluid or to drain used cleaning fluid from the at least part of the charge electrode and chamber 164. By virtue of being a branch of the second conduit 214, the third conduit 216 is not independently controllable of the second conduit 214 in the illustrated embodiment. Described another way, in the illustrated embodiment, when cleaning fluid is supplied through the second conduit 214, cleaning fluid is ejected from both the first port 206 (into the chamber 164) and the third port 217 (into at least part of the charge electrode). Similarly, where used cleaning fluid is drained through the second conduit 214, cleaning fluid is drained from the chamber 164 (through the first port 206) and from at least part of the charge electrode (via the third port 217). In some orientations (e.g. vertically upwards) of the print head 3, and so chamber 164, used cleaning fluid can be drained through both the first and third ports 206, 217. Advantageously, the first port 206 drains fluid from the chamber 164, whilst the third port 217 drains fluid from the charge electrode. Incorporation of the third port 217 thus avoids an accumulation of used cleaning fluid outside of the chamber 164 which could otherwise undesirably increase the drying time of the print head 3 following cleaning. However, in other embodiments one or more valves may be incorporated along the second and/or third conduits 204, 216 to provide independent control.

The third port 217 may also be referred to as the charge electrode drain port.

Turning to describe components of the cleaning module 13, first to fourth control valves 80, 81, 82, 83 are provided. Also extending at least partway through the cleaning module 13 is an air line 84, with an air pump 85 provided along the air line 84. A pressure release valve 86 is also provided downstream of the air pump 85. The air line 84 is connected to atmosphere and can be used to selectively supply the chamber 164 with air. This can be used for either positive pressure drying of the chamber 164 (e.g. after cleaning) or to provide a supply of air to within the chamber 164 during printing. This is to avoid an excessive negative pressure being generated within the chamber 164 due to the suction of the gutter pump 46 via the gutter 40, which could otherwise result in debris being drawn into the print head 3 from the printing line. Advantageously the single air pump 85 provides both functionalities.

A downstream portion of the cleaning module inlet line 72, which may be referred to as an inlet line 72 for brevity, is also shown. The break in the inlet line 72 between the left hand side of the Figure (i.e. above the filter 71) and the right hand side of the Figure (i.e. above the air pump 85) is simply included to improve the clarity of the Figure, and to avoid the line extending across the various other components of the fluid circuit. A draw line 87 is also shown. The draw line 87 extends to the gutter pump 46 via part of the gutter line 42. Fluid can therefore be drawn through the draw line 87 by operation of the gutter pump 46. For completeness, the gutter valve 87 also forms part of the cleaning module 13 in the illustrated embodiment. However, in other embodiments the gutter valve 87 could form part of the main ink block 11.

The first control valve 80 can selectively place the first conduit 204 (via a second control valve 81) in fluid communication with the inlet line 72 or the air line 84. The other of the inlet line 72 and the air line 84 can be selectively closed by the first control valve 80.

The second control valve 81 can selectively place the first conduit 204 in fluid communication with the draw line 87 or the inlet line 72 (via the first control valve 80) or the air line 84 (via the first control valve 80). In the configuration shown in FIG. 9, the second control valve 81 places the first conduit 204 in fluid communication with the draw line 87. Activation of the gutter pump 46 thus applies suction through the draw line 87 and through the first conduit 204. In this configuration, fluid would be drawn from the chamber 164 through the first conduit 204 and draw line 84. In the configuration shown in FIG. 9, the first conduit 204 is not provided in fluid communication with either of the inlet line 72 and the air line 84.

The third control valve 82 can selectively place the second conduit 214 in fluid communication with the draw line 87 or the inlet line 72 (via the fourth control valve 83) or the air line 84 (via the fourth control valve 83). In the configuration shown in FIG. 9, the third control valve 82 places the second conduit 214 in fluid communication with the draw line 84. Activation of the gutter pump 46 thus applies suction through the draw line 87 and through the second conduit 214. In this configuration, fluid would be drawn from the chamber 164 through the second conduit 214 and draw line 87. In the configuration shown in FIG. 9, the second conduit 214 is not provided in fluid communication with either of the inlet line 72 and the air line 84.

The fourth control valve 83 can selectively place the second conduit 214 (via the third control valve 82) in fluid communication with the inlet line 72 or the air line 84. The other of the inlet line 72 and the air line 84 can be selectively closed by the fourth control valve 83.

By selective operation of the control valves 80-83, different conduits/ports can be placed in fluid communication with the inlet line 72, air line 84 and draw line 87. When connected to the inlet line 72, cleaning fluid can be directed through the conduits/ports into the chamber 164. When connected to the air line 84, air can be pumped through the conduits/ports, by the air pump 85, into the chamber 164. When connected to the draw line 87, fluid (e.g. used cleaning fluid) can be drawn from the chamber 164, through the conduits/ports, through the draw line 87 by gutter pump 46. The air line 84 can be used to pump air into the chamber 164 to dry the chamber 164 after cleaning fluid has been drawn into, and drawn out of, the chamber 164. The air line 84 can also be used to pump air into the print head 3 (e.g. into the chamber 164) to replenish the air removed from the chamber 164 under action of the gutter 40 (e.g. during printing operations). This advantageously reduces the risk that the pressure within the print head 3 reduces to such a level that debris is drawn into the print head 3 from outside the print head 3.

In preferred embodiments, one of the first and second conduits 204, 214 is placed in fluid communication with the inlet line 72, and the other of the first and second conduits 204, 214 is placed in fluid communication with the draw line 87. Activation of the gutter pump 46 then draws cleaning fluid through the inlet line 72, into the chamber 164 via the conduit connected to the inlet line 72. The cleaning fluid is then drawn back out of the chamber 164, via the other conduit (e.g. whichever of the first or second conduits 204, 214 is not connected to the inlet line 72), under suction of the gutter pump 46 via the draw line 87. The selection of which port is a fill port, and which port is a drain port, can be based upon the orientation of the print head 3, and so chamber 164.

In preferred embodiments cleaning fluid is left in/resides in the chamber 164 for a dwell time before subsequently being drawn out/drained. Air may be bubbled through the chamber 164, whilst it is at least partly filled with cleaning fluid, to agitate the cleaning fluid and dislodge debris within the chamber 164. The chamber 164 may be only partially filled with cleaning fluid (e.g. around half full). The chamber 164 may be majority filled with cleaning fluid (e.g. at least around 80% of the chamber 164 volume filled with cleaning fluid).

Referring now to FIG. 10, which shows an axial cross-section of the charge electrode assembly 146 and adjacent parts of the attached nozzle body 143 in detail. The charge electrode assembly 146 and the nozzle body 143 are coupled in a fixable manner.

A set of axes is provided in FIG. 10. The z-axis is substantially parallel to a direction of the jet and droplet travel 310, also referred to as an ink travel axis. The z-axis is parallel to a central axis 301 of the charge electrode assembly 146, about which the charge electrode assembly 146 has substantial circular symmetry. The x and y-axes are mutually perpendicular and also both perpendicular to the z-axis.

The charge electrode assembly 146 comprises the charge electrode 148 and the insulating coupling 150 (also referred to as a charge electrode coupling 150). In the illustrated embodiment, the charge electrode 148 and insulating coupling 150 are rigidly coupled by the threaded fasteners 147 and 149, but other arrangements might be possible. The charge electrode 148 and insulating coupling 150 mutually compress a first gasket or O-ring 318 which hydraulically seals their interface.

It will be understood that any material that is both conductive and tolerant of ink contact (i.e. relatively chemically inert) would be suitable for the construction of charge electrode 148. For example, suitable materials include stainless steel, conductive plastics, aluminium alloy or titanium. Notably stainless steel is conductive and corrosion resistant -in addition it is simple and economical to fabricate parts from (e.g. by injection moulding).

The charge electrode 148 comprises a pair of rectangular planar glass windows 320 and a charge electrode body 322 defining an enclosed passage 328, bounded by an internal passage surface 330, extending substantially coaxially with the central axis 301 from an inlet aperture 324 at a first end 323 of the charge electrode body 322 to a second, opposite, end of the charge electrode body or spigot 329 which forms an outlet aperture 325. The first end of the charge electrode body 323 abuts against the insulating coupling 150 via the first gasket 318.

Insulating coupling 150 abuts the nozzle body 143 by means of a flat mating surface on both components. The nozzle body 143 and insulating coupling 150 mutually compress a second gasket 319. The insulating coupling 150 is toroidal, defining a central internal passage 316, so as to receive a projecting portion 306 of the nozzle body 143 and permit passage of the jet from the nozzle 144 (also known as a jewel) rigidly coupled to the nozzle body 143 through to the enclosed passage 328 along a direction or trajectory.

The nozzle 144 is retained in a cooperating recess 308 of the nozzle body 143 by a retaining ring 334.

The second gasket 319 circumferentially contacts the projecting portion 306 of the nozzle body 143. In an alternative, the second gasket could be configured so as to circumferentially contact the insulating coupling 150 (namely, by enlarging the second gasket), such an alternative is shown in FIG. 10 as 319a.

It will also be appreciated the insulating coupling 150 and/or the charge electrode body 322 may further comprise grooves or other features suitable for maintaining the alignment of the gaskets 318 or 319.

The spigot 329 seats into, and seals against, the flexible charge electrode boot 151. The nozzle 144 and charge electrode assembly 146 can thus be moved relative to a chamber of the wider printhead (referred to in FIG. 4 as 164).

The nozzle 144 is a planar element having a central orifice 332 in fluid communication with an upstream reservoir 333 which is a volume formed as an integral portion of the nozzle body 143. In use, ink in the volume is held at a pressure above ambient so as to expel a jet of ink from the orifice 332. In general, the nozzle orifice 332 is centred on the central axis 301.

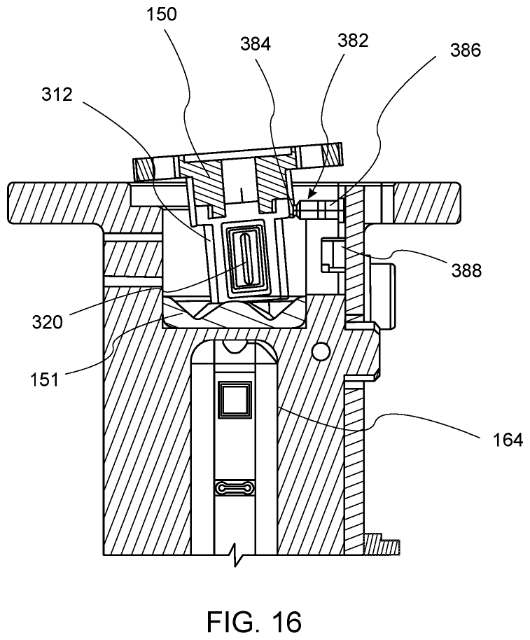

In use, insulating coupling 150 insulates the (charged) charge electrode 148 from the nozzle body 143, which is typically maintained at ground potential. The charge electrode 148 is subject to a varying voltage (more details of the electrical connection are furnished in connection with FIG. 16 below). Because the jet is subject to break-up in the proximity of the charged enclosed passage surface 330, the charge electrode 148 is capable of selectively inducing a variable charge on ink droplets by capacitive coupling, as is customary in the operation of electrostatic deflection continuous inkjet printers. The enclosed passage 328 has a first dimension in a first direction (x-axis) perpendicular to the travel axis and a second dimension different to the first dimension in a second direction (y-axis), the second direction being perpendicular to the first direction and the central axis 301. The second direction is parallel with the plane normal of the windows 320. These first and second dimensions vary along the length of the enclosed passage 328—thus, the axial cross section of the enclosed passage 328 varies along its the z-axis direction.

In the relation to the presently-described embodiment, the transverse cross sections of the charge electrode enclosed passage 328 are indicated in FIG. 10 at cross sections A, B, C and D. Cross section D is substantially circular—its first and second dimensions are substantially similar. At cross sections A and B, the first dimension of the enclosed passage is much larger than the second dimension (particularly cross section B). Cross section C is substantially a union of cross sections B and D.

As such, the variable cross sections define two main axially-disposed regions. A first region 327, which is substantially bounded by inlet aperture 324 and cross-section B, is configured to induce a charge on selected ink droplets by capacitive coupling at the point of jet breakup 311. It should be noted that the actual point of jet breakup 311 may vary according to ambient conditions and inherent characteristics of the ink and printer, among other factors. A second region 331, which is substantially bounded by cross section B and the outlet aperture 325 is configured to shield the charged ink droplets from external electromagnetic interference by enclosure of the passage 328 for at least a segment of the travel axis 310. The first region 327 and the second region 331 are located one on either side of the viewing apertures 321 (although both also span at least a part of the length of the viewing apertures 321 in the direction of travel of the ink jet).

The first region 327 has relatively small dimensions between the adjacent enclosed passage surface 330 and the (nominal) jet breakup location 311, so as to provide a reliable coupling between the charge electrode 148 and the ink jet without needing excessively high charge electrode voltages to be applied.

The second region 331, by virtue of its enclosed structure, blocks a direct line of sight from the high-voltage deflection electrode 168 (best seen in FIG. 5) to the jet breakup location 311, as well as other sources of electromagnetic interference. The second region 331 therefore does not require such small dimensions as the first region 327 in order to mitigate the detrimental effects of electromagnetic interference on droplet formation and flight. By providing larger dimensions, it is possible to allow increased tolerance for jet misalignment

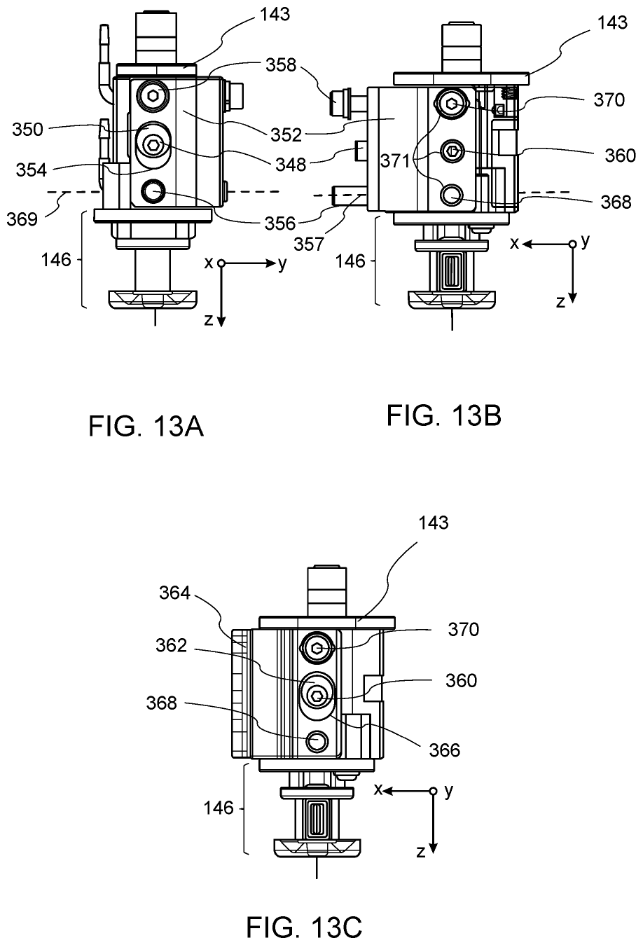

Additionally, by providing an enclosed passage 328 that does not have circular symmetry relative to the central axis 301 (i.e. different dimensions in directions perpendicular to the ink travel axis), a convenient mechanism for providing accurate positioning between the charge electrode and the ink jet can be achieved. For example, the charge electrode can be rotated so that the jet is centred between opposing passage walls—such a mechanism will be described in detail with reference to FIG. 13A, B and C.

The nominal ink travel axis may also be referred to a central printhead axis and refers to an expected direction of travel of ink from the nozzle. However, manufacturing tolerances may result in a (small) misalignment between the ink jet direction 310 (i.e. the ink travel axis) and the central printhead axis (e.g. up to 1.5 degrees). The components of the printhead (e.g. the nozzle body 143, gutter block 182 of FIG. 8 etc.) will have been designed based upon the central printhead axis, or nominal ink travel axis. However, the actual ink travel axis 310 may vary between printheads, and may be not be determined until the components of the printhead have been fully assembled.

The second region 331 which encloses the passage 328 from the jet breakup location 311 to the outlet aperture 325 may primarily shield the droplets, and may, therefore not require such small dimensions. By providing larger dimensions, it is possible to allow increased tolerance for jet misalignment.

In an example, the first region 327 may be around 4-6 mm in length and the second region 331 may be around 5-7 mm in length (i.e. the dimensions parallel to central axis 301).

FIG. 11 illustrates a perspective view of charge electrode assembly 146 and nozzle body 143 from the side. The pair of windows 320 is arranged about the enclosed passage being seated adjacent to corresponding viewing apertures 321. The pair of viewing apertures 321 are defined by openings in the charge electrode body 322

By providing viewing apertures 321, it is possible to view the jet breakup location 311 within the charge electrode 148. The viewing apertures 321 are closed by the pair of transparent windows 320, allowing the enclosed passage 328 to remain sealed from the region outside the charge electrode, while still permitting the enclosed passage 328 to be viewed. In some alternative variants, the viewing apertures 321 may remain unsealed. The windows 320 and viewing apertures 321 are substantially opposite each other so as to provide a direct light path 340 substantially perpendicular to, and through the central axis 301 of the enclosed passage 328. The pair of windows 320 are substantially rectangular.

By providing a pair of opposed viewing apertures 321, it is possible to view the jet breakup location through the charge electrode, while providing an (e.g. strobed) external backlight 388 (best seen in FIG. 16) to enhance clarity of imaging. The light path 340 allows observation or inspection of the point of jet breakup 311 by optical means, for example by means of a camera (not shown).

A backlight could alternatively be directly provided in-situ by providing a light source such as an LED in place of one of the windows 320.

In an example, observation of jet-breakup can be made easier by means of strobe LED backlights. A backlight is strongly advantageous as the resultant image formed by the jet is a silhouette, easing inspection. Where the LED strobe frequency is closely matched to an integer divisor of the jet breakup frequency, then the resulting image has the effect of showing an apparent static image of jet breakup (cf. stroboscopic imaging). This makes inspection of jet breakup geometry much easier. For instance, such a technique may be used to accurately determine the exact position at which the jet breaks up into droplets.

Preferably, a backlight would be provided by one or more red LEDs, as the CCD sensors of many cameras used for imaging are more sensitive to red visible light.

FIG. 12 shows the insulating coupling 150 and nozzle body 143 from a different perspective. The wider charge electrode assembly 146 has been omitted for clarity, but its connection to the insulating coupling 150 is easily understood with reference to FIG. 10.

The insulating coupling 150 is of a substantially toroidal geometry; the toroid cross section substantially resembles a ‘step’, defining a bore with a radially-projecting flange 342. The flange 342 integrally defines three enclosed axially-concentric guide surfaces 346 by means of semi-annular slots 347 in a rotationally symmetric arrangement. Note that the term semi-annular here may designate any annular profile subtending any angle less than 360°.

The central passage 320 of the insulating coupling 150 receives the complementary nozzle body projection 306 (Best seen in FIG. 10). Because of the complementary circularly-symmetric geometry of the central passage 316 and nozzle projection 306, which resembles a journal (a guide surface) and bearing (a guide element), only rotational relative motion about the central axis 301 is possible.

The charge electrode assembly 146 is coupled to the nozzle body 143 by means of a pair of bolts (or more generally, guide elements) 344 which pass through the two of the three enclosed semi-annular slots 347 in the insulating coupling 150 and are received in corresponding threaded holes in the nozzle body 143. The pair of bolts 344 are at 180 degrees from each other, such that their axes lie on a common line. In the presently-described embodiment, the axially-concentric guide surfaces 346 and/or semi-annular slots 347 subtend an angle around 90 degrees but less than 120 degrees.

The above-described coupling arrangement between the charge electrode assembly 146 and nozzle body 143 facilitates two coupling configurations: an adjustment configuration and a fixed configuration.

In the adjustment configuration, the bolts 344 are untightened. As such, the insulating coupling 150, and by extension the wider charge electrode assembly 146, can be coaxially rotated to perform adjustments. The sliding contact of the guide surfaces 346 and their corresponding bolts 344 (also the central passage 316 and nozzle body projection 306, as best seen in FIG. 10) facilitate rotation, but interfere with any translational movement.

Having adjusted the rotational position of the charge electrode assembly 146 as necessary, the adjustment can be made permanent by changing the mounting arrangement to a fixed configuration. In the fixed configuration, the bolts 344 are tightened so as to exert a clamping force between the charge electrode assembly 146 and nozzle body 143. The aforementioned clamping force prevents any relative movement of the charge electrode assembly 146 and nozzle 144. This lack of relative movement means adjustments of the orientation of nozzle 144 and charge electrode 148 (and hence the jet direction 310) occur in tandem.

In this way, adjustments can be made during a manufacturing, assembly, servicing, or calibration operation, with an adjusted charge electrode configuration then being fixed for subsequent use during printing operations.

As described above, manufacturing tolerances in the inkjet nozzles such as nozzle 144 may result in ink jet misalignment. This can be accommodated by adjusting the relative position between a gutter configured to catch un-printed ink droplets and the nozzle. However, any jet misalignment may result in imperfect alignment between the ink jet (and ink droplets, once separated from the ink jet) and the charge electrode. This can have a variety of detrimental effects of print quality, including, for example, distortion to the amount of charge induced on droplets, disturbance to the droplet direction, and even, in severe circumstances, collision between the droplets and the charge electrode which is also known as ‘clipping’.

By providing a mounting arrangement that couples the charge electrode to the nozzle (e.g. the arrangement described with reference to FIG. 12), while also permitting the charge electrode position to be adjusted, the effects of any jet misalignment can be mitigated. That is, by mounting the charge electrode 148 to the nozzle 144 via the nozzle body 143 (rather than to a printhead deck, for example), any movement or adjustment of the nozzle 144 (e.g. to ensure alignment of the ink jet with the gutter) will also cause a corresponding movement of the charge electrode 148).

The geometric configuration of the concentric guide surfaces 346, through which the bolts 344 pass, allows the insulating coupling 150 (and by extension the wider charge electrode assembly 146) to be rotated through any rotational alignment degrees relative to nozzle body 143 and secured by tightening the bolts 344 whilst maintaining them in coaxial alignment. It will be appreciated that in order to achieve the full range of rotational alignments, the bolts 344 may need be to removed entirely and the charge electrode assembly 146 rotated by 180 degrees such that the bolts 344 can be aligned with different slots 347

By providing three guide surfaces 346 each allowing a rotation extent of 90 degrees, it is possible to compensate for jet misalignment in many directions.

By providing an extent of rotation of 180 degrees or more, it is possible to align the charge electrode 148 with all possible jet misalignments, this is because of the 2nd order rotational symmetry of the enclosed passage 328 about the central axis 301

In alternative embodiments, a 180-degree extent of rotation or greater could be provided by varying the number of slots, bolts and/or their geometries.

A variant arrangement is illustrated schematically in FIG. 18A, an arrangement comprising a major (semi annular) slot 512, a minor (semi annular) slot 514, two bolts (omitted for clarity) and three threaded holes 516a, b, c. The slots are of unequal extent, with the larger major slot 512 subtending an angle of at least 180 degrees. Two of the threaded holes, 516a and 516b, are disposed substantially opposite to the third threaded hole 516c, so as to enable both bolts to be secured in any rotational orientation, even when one of the threaded holes is occluded by the insulating coupling 150, a situation illustrated in FIG. 18B.

Another variant arrangement comprises three congruent slots disposed at 120 degree intervals about the insulating coupling flange, three threaded holes disposed in the nozzle body at 120 degree intervals and three corresponding bolts. In order to allow an effective 180-degree extent of rotation, the slots must subtend at least 60 degrees. The structural integrity of the insulating coupling means the slots must subtend less than 120 degrees. In the adjustment configuration, the interaction of bolts and slots limits the rotation, but removal of the bolts allows the slots to align with a different threaded hole, allowing a further set of rotational positions, of which there are three overall.

The nozzle body 143 further comprises a nozzle adjustment mechanism, shown in two different views in FIGS. 13A, 13B and 13C, configured to permit adjustment of the orientation of the nozzle 144 (not visible in FIGS. 13A, 13B and 13C) relative to the gutter to compensate for ink jet misalignment with the gutter (i.e. alignment of the jet travel direction 310 and the central printhead/nominal ink travel axis).

The nozzle body 143 can be tilted or rotated about a first and second mutually orthogonal tilt axes parallel (referred to 357 and 369, respectively) to the x and y-axes respectively—i.e. they are mutually perpendicular with the central axis 301 and the z-axis. Such tilts or rotations are effected by a first and second tilt axis mechanism.

The first tilt axis 357 adjustment mechanism (best seen in FIGS. 13A and 13B) comprises a first adjustment screw 348 rigidly coupled to an eccentric circular first cam 350, a first nozzle cradle 352 which defines a first camming surface 354, a first pivot axle or first pivot 356 and a first locking screw 358. The first nozzle cradle 352 may be the same component as the nozzle cradle referenced as 142 in relation to FIG. 3 above. The first pivot 356 pivotally couples the first nozzle cradle 352 to the wider printhead. The first cam 350 bears against the corresponding first camming surface 354. The first adjustment screw 348 and locking screw 358 are also pivotally coupled to the wider printhead. The first adjustment screw 348, first locking screw 358 and first pivot 356 are mounted in-line with the central axis 301 with their rotation axes parallel.

The first camming surface 354 comprises a recess in the first nozzle cradle 352, sized such that the circular first cam 350 can be seated in the recess with its circumference in partial contact with the edges of the recess 355.

The first tilt axis 357 (best shown in FIG. 13B) is defined by, and coaxial with, the pivot 356.

The first cam 350 brings about rotation about the first tilt axis 357: rotating the first cam 350 causes a displacement of the first adjustment screw 348 relative to the first nozzle cradle 352 as a result of the eccentric geometry of the first cam 350. The displacement of the first nozzle cradle 352 relative to the wider printhead under the constraint of the first pivot 356 produces rotation of the first nozzle cradle 352 about the first tilt axis 357. The extent of the aforementioned rotation or tilt is determined by the extent of rotation of the first adjustment screw 348, and by extension the first cam 350.

The second tilt axis adjustment mechanism is described with reference to FIGS. 13B and 13C. FIG. 13C shows the aforementioned adjustment mechanism from the same perspective as FIG. 13B (as indicated by the provided axes). However, in order to better show the second tilt axis adjustment mechanism, the first nozzle cradle 352 is omitted.

The second tilt axis adjustment mechanism comprises a second adjustment screw 360 rigidly coupled to an eccentric circular second cam 362, a second nozzle cradle 364 which defines a second camming surface 366, a second pivot axle or second pivot 356 and a second locking screw 370.

The second nozzle cradle is rigidly coupled to the nozzle body 143, with the first nozzle cradle 352 adjacent to, and wrapping around it.

The second pivot 368 pivotally couples the second nozzle cradle 364 to the first nozzle cradle 352. The second cam 350 bears against the corresponding second camming surface 366. The second adjustment screw 360 and locking screw 370 are pivotally coupled to the second nozzle cradle 364: they are partially captive in corresponding holes 371 in the first nozzle cradle 352. The second adjustment screw 360, second locking screw 370 and second pivot axle 368 are mounted in-line with the central axis 301 with their rotation axes parallel.

The second camming surface 366 comprises a recess in the second nozzle cradle 364, sized such that the circular eccentric second cam 362 can be seated in the recess.

The second tilt axis 369 (best shown in FIG. 13A) is defined by, and coaxial with, the second pivot axle 368.

As a close mechanical analogue to the first tilt axis adjustment mechanism, rotational displacement is also achieved by very similar means-a rotation of the second adjustment screw 360 results in tilt of second nozzle cradle 364 under cam pressure from the second cam 362, and by extension the nozzle body 143, about the second tilt axis 369. Because the second nozzle cradle 364 is itself subject to tilt about the first tilt axis 357, the nozzle body 143 itself can be subjected to tilt in both tilt axes 357 and 369 so as to permit full adjustment of the nozzle 144 orientation.

Any adjustments obtained in the above-described manner may be fixed by tightening the first locking screw 348 and the second locking screws 370, which exert a clamping force on the first nozzle cradle 352 and second nozzle cradle 364 respectively by virtue of their threads.

Turning briefly now to FIG. 16 which shows a section of the printhead with a nozzle adjustment applied. In order to maintain electrical connection, the charge electrode 148 is electrically connected by means of a spring-loaded pin 382, which may be also referred to as a pogo pin, mechanically coupled to the wider printhead and electrically connecting the printer controller 6 (as seen in FIG. 1) and charge electrode 148. The spring-loaded pin 382 comprises a follower contact 384 held captive in a cylindrically-bored body 386 under expansive spring pressure from an internal spring (obscured). The spring-loaded contact can thus axially contract and expand against the charge electrode 148 exterior, complying with adjustments, whilst conducting electricity. In consequence, the follower contact 382 maintains constant mechanical pressure upon, and hence electrical contact with, the charge electrode 148 throughout adjustments in the charge electrode orientation.

In alternative embodiments the charge electrode 148 could also be connected by directly bonding (e.g. soldering) or clamping a compliant connection to the printer controller 6 (as seen in FIG. 1), for example via a flexible wire.

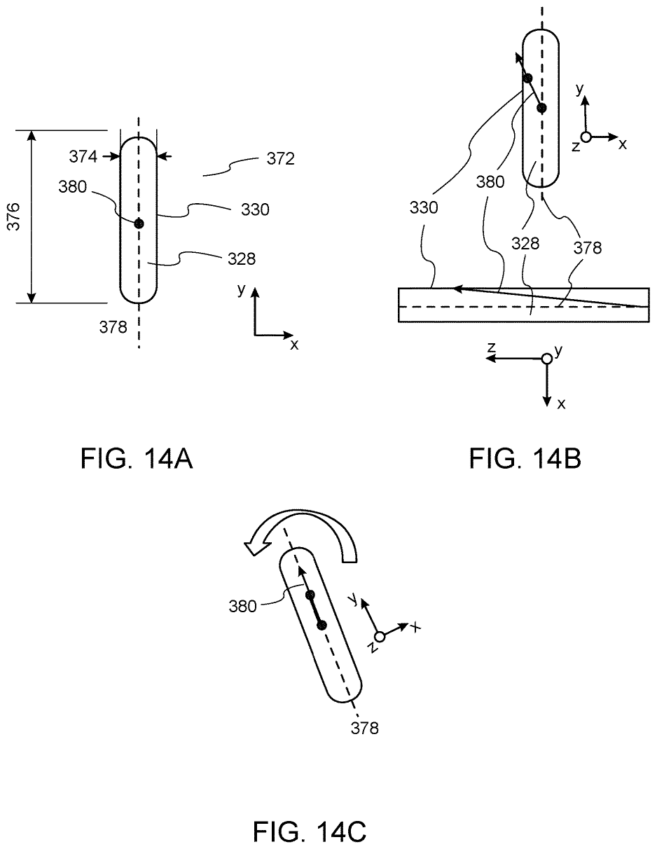

FIG. 14A illustrates a charge electrode passage transverse cross-section 372 in the vicinity of point B of the embodiment described with reference to FIG. 10. Here, transverse cross section indicates that the plane is perpendicular to the central axis 301, described with reference to FIGS. 10, 11 and 12.

The enclosed passage 328 has a ‘slot-like’ cross section—i.e. there is a minor (x) dimension 374 and a major (y) dimension 376. There is a central plane of symmetry parallel 378 to the YZ-plane. The minor dimension allows close proximity between an incoming jet 380 and the charged enclosed passage surface 330, strengthening the capacitive coupling between the enclosed passage surface 330 and any nascent droplet forming at the point of jet break-up 311 (best seen in FIG. 10).

In ideal operating conditions, the enclosed passage 328 and the direction of the jet 380 generated by the nozzle are perfectly coaxial, as shown in FIG. 14A. As a consequence, the jet direction 380 traverses the central plane of symmetry 378. Briefly referring back to FIG. 10, such a perfectly coaxial alignment would mean that the central axis 301 would align with the direction of jet and droplet travel 310.

In practice, the jet direction 310 (indicated in FIG. 10) is often not coaxial with the central axis 301, due to manufacturing tolerances or imperfect assembly. The jet may exhibit a trajectory having significant skew relative to central axis 301. Such misalignment may be due to adjustment of the nozzle body 143. Misalignments of the jet may lead to undesirable lateral forces and in extreme cases, clipping.

Such a situation is shown in FIG. 14B which shows a frontal and top view of a misaligned jet 380 within the enclosed passage 328. As a result of the misalignment, the jet 380 is not coplanar with and/or does not traverse the central plane of symmetry 378. The relatively greater extent of the major dimension 376 of the enclosed passage 328, means that a jet with a large y-component in its trajectory may pass through the charge electrode 148 without clipping the enclosed passage surface 330. However, jets with a significant x-component will clip the enclosed passage surface 330, due to the restricted minor dimension 374 of the enclosed passage 328.

By providing a charge electrode passage having a slot-like shape, it is possible to provide a close separation between the passage surface 330 and the inkjet at the ink break-up point (due to the smaller minor dimension 374), and a degree of insensitivity to jet misalignment (due to the larger major dimension 376). Rotation of the charge electrode assembly 146 permits the separation in the smaller dimensions to be oriented so that the enclosed passage surface 330 is substantially the same distance from the ink jet on each side (i.e. the jet 380 traverses the central symmetry plane 378), thereby promoting even charging, and avoiding unnecessary droplet distortion and deflection. On the other hand, the larger dimension can be aligned with the central plane of symmetry 378 and the central axis 301 by means of rotation of the charge electrode assembly 146 as shown by comparison of FIGS. 14B and 14C. FIG. 14C shows the results of such an adjustment.

The presently-described embodiment may be realised at a variety of dimensions. For example, the first (minor) dimension of the enclosed passage 328 may be between 0.5-1 mm; and the second (major) dimension of the enclosed passage 328 may be around 1-5 mm. The first dimension may be between around 0.7 mm and 0.8 mm. The second dimension may be between around 1.2 mm and around 1.5 mm.

Referring back to FIG. 10, the charge electrode boot 151, the first gasket 318 and second gasket 319 define a substantially hydraulically-sealed volume comprising the enclosed passage 328.

The aforementioned hydraulically-sealed volume is in fluid communication with the chamber of the wider printhead (referred to in FIG. 4 as 164). The first and second gaskets (318, 319) seal a conduit between the nozzle 314 and enclosed passage 328 through which ink is ejected during printhead operation, and on which undesirable deposits of ink may form.

The boot 151 is a flexible and compliant sealing element, sealing an exterior surface of the charge electrode 326 and chamber 164 of the wider printhead from each other, whilst allowing a degree of relative movement between the charge electrode assembly 146 nozzle body 143 and the printhead chamber. In an example, the boot 151 may be an O-ring or corrugated elastomer washer. In this way, adjustments can be made to the charge electrode 148 (and possibly attached nozzle 144) without also moving the wider printhead 3 (as seen in FIGS. 1, 2 and elsewhere) and maintaining the required hydraulic sealing.

As described with reference to FIGS. 2-9, the presently-described printhead has a printing configuration in which the ink aperture 106 is open (Best seen in FIG. 2) and cleaning configuration in which the ink aperture 106 is closed. In the cleaning configuration the printhead defines an enclosed cleaning chamber, the enclosed cleaning chamber being defined by the enclosed passage 328, nozzle 144 and chamber 164.

In this way, the enclosed cleaning chamber defined within the printhead 3 is configured such that cleaning fluids may be pumped thereto, flooding the enclosed cleaning chamber. Any ink deposits are then dissolved and the cleaning fluid drained to clean away any ink deposits, allowing the enclosed passage of the charge electrode 328 and the surface of the deflection electrode 168 (best seen in FIG. 5) to be cleaned. These operations are described above in more detail with reference to FIG. 9.

Advantageously the definition of a hydraulically-sealed enclosed cleaning chamber within the printhead 3 comprising the nozzle 144, enclosed passage 328 and chamber 164 minimises volume to be flooded during cleaning. Because the components outside the cleaning chamber are not exposed to ink during printing operations, there is no need to expend excess cleaning fluid to clean them.

Furthermore, the hydraulically-sealed nature of the aforementioned enclosed cleaning chamber precludes leakage of hazardous cleaning fluids from the printhead 3 rendering self-cleaning a safer, more convenient and more contained process than previous methods.

Fluid entry or exit (i.e. draining and filling) into the aforementioned internal volume is facilitated by the charge electrode drain port 217, best seen in FIG. 17 which renders the insulating coupling 150 semi-transparent to better show the drain port 217. The charge electrode drain port 217 is situated in the nozzle body 143, porting into the recess for the second gasket 319, best seen in FIG. 10. Charge electrode drain port 217 can also feed air so as to aid in draining or drying of the printhead. The drain port 217 is in fluid communication with the aforementioned internal volume via a set of six bypass channels 343 radially disposed about the insulating couple central passage 316. It will be appreciated that the bypass channels may be totally or partially occluded by the second gasket 319, and consequently the alternative gasket configuration 319a described with relation to FIG. 10 may be used.

Depending on the cleaning configuration chosen by the user, charge electrode drain port 217 may be a drain port, a fill port.

It should be understood that the invention has only been described by way of example. The skilled person would understand that a multitude of variants are possible, for example variations in construction, scale and/or geometric configuration could be made with no substantial change to the function of such a device.

In the embodiment described above with reference to FIGS. 10-14B , the windows 320 are discrete glass parts fixed to the conductive charge electrode body. A possible alternative would be to form them as a transparent plastic over-moulding over an underlying conductive metallic structure.

The charge electrode may comprise a transparent body. It will be appreciated that 100% transparency is not required, rather a sufficient degree of transparency to allow the jet breakup position to be viewed.

It will be appreciated the above-detailed transparency requirement (or lack thereof) may refer to either or both the characteristics of light transmission and/or scattering and the area coverage of transparent material.

The charge electrode may comprise a both transparent and conductive charge electrode body. The charge electrode may comprise a transparent and conductive charge electrode body or a transparent and non-conductive charge electrode body having a transparent conductive coating. For example, a one-piece non-conductive, transparent plastic moulding with sputtered Indium Tin Oxide (ITO) conductive coating on the passage surface. Such a structure would permit 360° visibility of the internal enclosed passage, whilst still being conductive so as to permit selectively charging droplets.

Alternative embodiments may not just be limited to material or manufacturing variants but also the configuration of the charge electrode itself.

For example, in some embodiments, the mounting arrangement described herein may be applied to a charge electrode assembly in which the enclosed passage is not entirely enclosed. Gaps, apertures, or openings other than the inlet and outlet apertures may be provided. By enclosed it is not, therefore, intended to mean fully or entirely enclosed. Rather, the passage is enclosed or surrounded, to some extent, so as to allow charge to be induced on the ink droplets by capacitive coupling. In such an arrangement, alternative cleaning arrangements may be provided to those described in detail above. For example, the printhead housing may define a cleaning chamber within which the charge electrode is fully contained for cleaning. Alternatively, any additional opening(s) may be sealed for cleaning by appropriately configured sealing mechanism(s). In a further alternative, such a printhead may be inserted into a separate cleaning device for cleaning. It will be appreciated, therefore, that the charge electrode assembly and mounting arrangement described herein is not limited to fully sealed assemblies in which a fluid seal is made between the charge electrode and the nozzle on the one hand and the printhead body on the other.

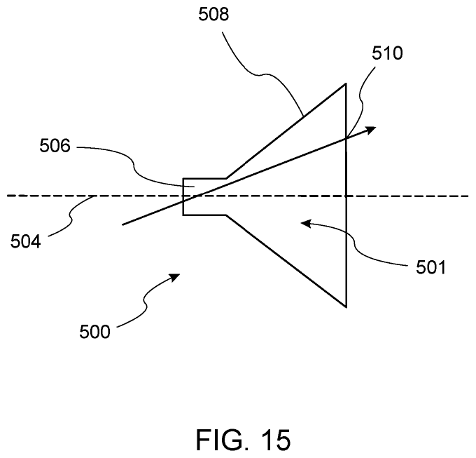

As shown in FIG. 15, in a further alternative charge electrode embodiment 500, having an enclosed passage 501. The charge electrode enclosed passage 501 geometry may be a volume of rotation with a central bore-axis 504. The volume of rotation comprises a first small narrow parallel section 506. The narrow parallel section 506 may be joined to a diverging second conic section 508, oriented such that a jet enters through the first section 506 and exits from the second section along the bore-axis. Such a geometry can tolerate large angular misalignment due to the relatively large conic section 508 (see jet 510) provided the jet intersects the bore-axis at the first narrow section. Because of its small dimensions and the resultant close proximity to the ink jet 510, the first section 506 is configured to provide reliable coupling between the charge electrode 500 and the nascent droplets.

It will be appreciated that a variety of diverging geometries could also provide an equivalent function to the second conic section 506. The radius of the second section may have any monotonically or non-monotonically increasing relationship with the central bore-axis.

Charge electrode embodiment 500 may advantageously be fabricated at least in part from conductive materials. In an example, it could be substantially composed of clear conductive plastic-facilitating both charge induction on nascent droplets by capacitive coupling and also visual observation of the jet. Alternatively, the narrow parallel section 506 could be composed of a narrow conductive (e.g. stainless steel or any other metal) tube having an observation aperture which may be press fit into a wider plastic body.

In general, whilst the embodiment of FIGS. 10-14B specifies the use of a semi-annular slots 347 and bolts 318 to serve as guide surfaces and elements respectively. However, alternative arrangements achieving an equivalent effect are also possible. For example, guide pins could be substitute guide elements in place of the aforementioned bolts. In another example, a system of mechanically-cooperating lugs on the nozzle body and recessed tracks on insulating coupling would fulfil the function of a guide elements and surfaces respectively.

It should be noted that the alternative example guide surface and guide element arrangements would require a separate mechanism (e.g. further threaded fasteners) to secure the arrangement after adjustment.

In the embodiment of FIGS. 10-14B the semi annular slots 347 are defined by the flange 342 of insulating coupling 150. Alternatively, equivalent semi-annular slots could also be provided in a flange provided on the charge electrode itself, corresponding bolts could then pass through the slots into corresponding threaded holes in the nozzle body, bypassing the insulating coupling. It will be appreciated, that in order to maintain electrical isolation of the charge electrode and nozzle body, the bolts and/or recesses would need to be insulated.

In another alternative guide surface and element arrangement, the charge electrode may be captured in a toroidal ‘ferrule’ coupled to the nozzle body. The ferrule shoulders being configured to clamp down the charge electrode as needed, for example by means of cooperation with external threads on the nozzle body. Such an embodiment is described below.

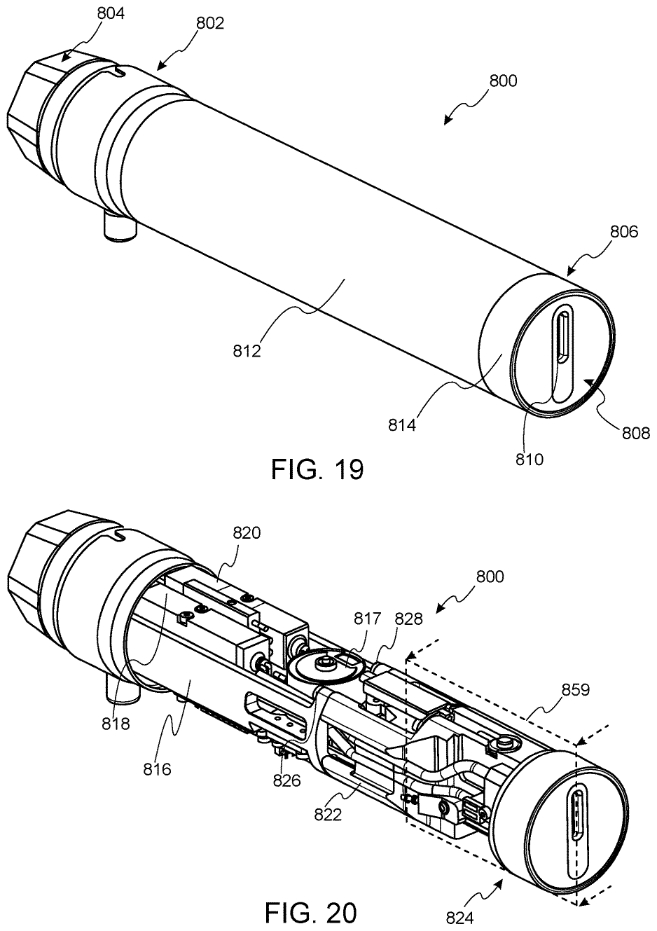

Turning to FIG. 19, a perspective view of a print head 800 according to another embodiment is provided. For completeness, the print head 800 shares various features in common with the print head 3 shown in FIGS. 2 to 8, and only the differences relative to the print head 3 will be described in detail. The print head 800 can also be used in the printer 1 of FIG. 1 and in the fluid system shown in FIG. 9. Equally, the description provided in connection with FIGS. 10 to 18 also applies, where appropriate, to the print head 800. The print head 800 is thus also a self-cleaning print head.

At a first end 802 the print head 800 comprises a connector 804 by which the print head 800 is connectable to the umbilical. At a second end 806 of the print head 800 an end cap 808 is provided. There are a number of differences between the end cap 808 of the print head 800 and the earlier embodiment, which will be described in detail below. The print head 800 comprises a single ink aperture 810 However, the ink aperture 810, through which deflected ink is ejected in operation, is still defined through the end cap 808. An outer shell 812 is generally cylindrical and extends along a majority of the print head 800. A sealing cover 814 extends adjacent the outer shell 812, proximate the second end 806 of the print head, and extends around, and slightly beyond, the end cap 808. The combination of the outer shell 812 and sealing cover 814 define an outer cover of the print head 800, the outer cover being removable for maintenance.

Turning to FIG. 20, a perspective view of the print head 800 is provided with the outer shell 812 omitted. As will be appreciated by comparing FIG. 20 with FIG. 3, there are various similarities between the print head 800 and print head 3. Again, only the differences will be described in detail.

Briefly, the print head 800 comprises a chassis 816 to which various other components are mounted. A motor 817, a brushless DC motor in this embodiment, is also mounted to the chassis 816. A solenoid valve 818 and valve block 820 are also mounted to the chassis 816. A chamber housing 822 is connected to the chassis 816 and, at the other end, is coupled to a sealing mechanism 824, which is actuated by motor 817. The sealing mechanism 824 may be described as an example of a cap assembly. Other examples of cap assemblies may not be sealing mechanisms. For example, a non-self-cleaning print head may comprise a cap assembly, but not use a sealing mechanism.

One difference between the print head 800 and the print head 3 can be observed by comparing FIG. 20 with FIG. 5. Unlike the print head 3, in the print head 800 the chamber housing 822 is connected to the chassis 816 and the sealing mechanism 824. That is to say, multiple housing components are eliminated by using the single chamber housing 822. Furthermore, the chamber housing 822 can be detached from the chassis 816, and moved away therefrom, by removing four fasteners, two of which are visible in FIG. 20 and labelled 826, 828 respectively. This is advantageous for at least the reason that various components for which servicing may be of interest are mounted to the chamber housing 822. These components can also be readily detached from the chassis 816 to facilitate servicing.

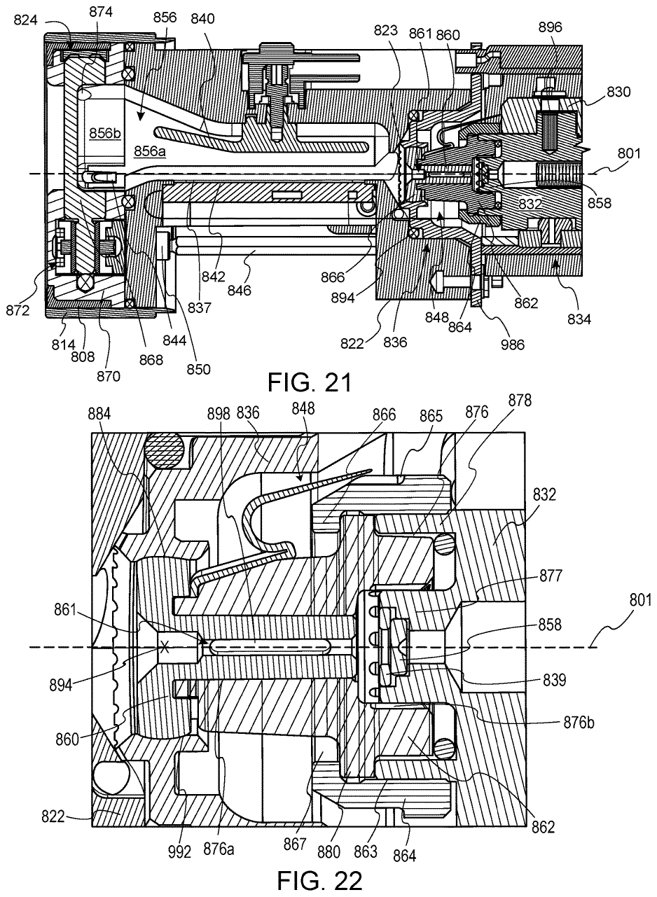

At FIG. 21, an axial cross-section of the print head 800 in the configuration shown in FIG. 20 (i.e. with the outer shell admitted) is provided. The cross-section is taken about the plane 859 schematically indicated in FIG. 20.

As in the previous embodiment the deflection electrodes 840, 842 are disposed in the chamber 856. By virtue of sealing the chamber 856, and at least partially filling the chamber 856 with cleaning fluid, these components can thus be cleaned. Other components which may be cleaned as part of a cleaning cycle include a gutter 844 and rotatable body 868.

A first portion 856a of the chamber 856 is defined by the chamber housing 822. A second portion 856b of the housing 856 is defined by a casing 870. The casing 870 forms part of the sealing mechanism 824. It is with respect to the casing 870 that the rotatable body 864 can rotate to selectively seal the chamber 856 (e.g. by closing an ink aperture defined by the casing 870). The endcap 808 is shown disposed over the casing 870. This will be described in detail in connection with the later figures. The rotatable body 868 is actuated, by shaft 846, via a socket 850 and a gearing arrangement generally labelled 872.

The gutter 844 is visible in FIG. 21, the gutter 844 being provided downstream of the pair of deflection electrodes. Notably, the gutter 844 is not coupled to the sealing mechanism 824. As such, the sealing mechanism 824 can be removed whilst leaving the gutter 844 in position. Put alternatively, the gutter 844 has a fixed spatial relationship to the chamber housing 822.

Printhead 800 further comprises a nozzle assembly 834 and charge electrode assembly 848. The charge electrode assembly 848 comprises a charge electrode 860 and a mounting arrangement. The nozzle assembly 834 comprises a single nozzle 858 and a single nozzle body 832. The charge electrode assembly 838 and nozzle assembly 834 are coupled together axially by means of the mounting arrangement. The nozzle assembly 834 further comprises nozzle cradle 830, to which a nozzle body 832 is coupled.

The charge electrode assembly 848 is pivotally coupled to the wider printhead, specifically the chamber housing 822, by means of a ball-joint (or ball and socket) arrangement which will be discussed in more detail below. Nozzle cradle 830 is engaged by two screws 896—one of which is visible in FIG. 21. Advancing each screw 896 urges the nozzle body 832 to pivot in a direction—selectively adjusting each screw 896 facilitates precise control of the orientation of the nozzle body 832.

It will be understood that the gutter is rigidly coupled to the charge electrode mount by a single part, the chamber housing 822. By reducing the number of connections between the gutter 844 and the nozzle 858, the likelihood of nozzle 858 moving out of alignment (e.g. over the service life of printhead 800) with the gutter 844 is reduced. In an alternative, the chamber housing may comprise multiple component parts, but the gutter may be rigidly coupled to the charge electrode mount by a single component part.

At FIG. 22, an axial cross-section view of the charge electrode assembly 848 and surrounding components (e.g. chamber housing 822). FIG. 22 shows the structural details of the combined charge electrode assembly 848 and adjacent parts of nozzle assembly 834 in situ within the printhead 800. The charge electrode assembly 848 comprises a charge electrode 860 and a charge electrode coupling 862.

The charge electrode 860 (shown in detail in FIG. 25) defines a passage 861 for charging ink droplets. Charge electrode 860 is of comparable geometry and function to charge electrode 148 of printhead 3 described with reference to FIGS. 10 and 11. Put alternatively, charge electrode passage 861 has a narrow non-circular cross-section, in particular its cross section may correspond to some or all of the cross-sections A-D of charge electrode 148 of FIG. 10. In contrast to its exterior geometry which is substantially a volume of rotation. The charge electrode further comprises a pair of viewing apertures 898 for visual inspection of jet break-up of the ink jet.

The charge electrode may be formed from any conductive material, for example stainless steel.

The mounting arrangement comprises a charge electrode coupling (or coupling) 862, configured to couple the charge electrode 860, and a clamping nut 864, configured to hold the charge electrode coupling against the nozzle body 832.

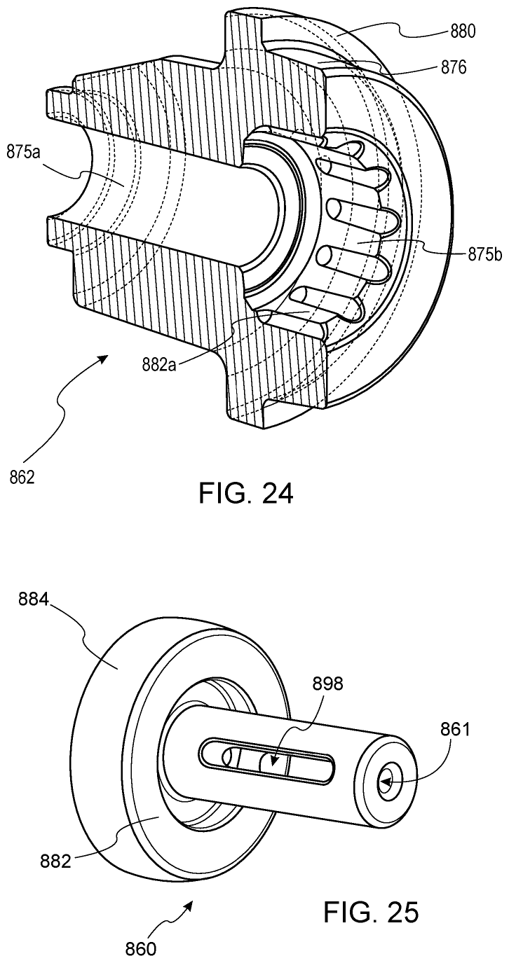

The coupling 862 is an axisymmetric component (features of which are best seen in FIG. 24, a sectioned perspective view of the coupling) having a first cylindrical socket 875a at a first end to receive the charge electrode 860 via a press fit and a second cylindrical socket 875b at a second end to receive a cylindrical projecting portion 877 of the nozzle body 832 (which supports the nozzle 858, retained by retaining ring 839), forming a cylindrical interface. The outer surface 876 of the second end (itself forming a cylindrical projecting portion) is itself received by a cylindrical nozzle body socket 878 disposed concentrically about the projecting portion 877, forming a further cylindrical interface. The concentric cylindrical interfaces between the coupling 862 and the nozzle body 832 permit rotation of the coupling and, by extension, relative rotation of the charge electrode 860 and the nozzle body 832 about a nominal axis of ink travel 801. The mounting arrangement is configured to permit rotation of the charge electrode 860 relative to the nozzle 858 through an unlimited extent. This permits the alignment of the charge electrode 860 with any ink jet misalignment in a similar manner to that described with reference to the FIGS. 14A-C. The coupling 862 further comprises a flange 880 disposed between the first and second ends.

In order to electrically isolate the charge electrode 860 and the nozzle assembly 834 (best seen in FIG. 21) from each other, the coupling 862 may be substantially composed from an electrically-insulating material. In addition, in order to allow visual inspection of ink jet break-up via the pair of viewing apertures 898, the coupling 862 may also be transparent. In an example, the coupling 862 may be substantially formed from transparent plastic and/or glass.

In some embodiments, the viewing apertures may be covered by a clear glass or sapphire tube fitted over at least a portion of the charge electrode, providing clear windows for observation of ink jet break up. The combined charge electrode and clear tube may be fitted into the coupling by mechanical or adhesive means. In such embodiments, the coupling need not be transparent and can instead define openings exposing the clear windows. Glass and sapphire may be particularly suitable materials for the tube due to their chemical inertness and resistance to solvent attack.

In printhead 800, charge electrode 860 and the coupling 862 are separate components. In an alternative, the charge electrode and coupling may be integrally formed with each other. For example, the coupling may be formed from a single transparent plastic/glass component with an indium tin oxide (ITO) coated bore or passage-the conductive ITO functioning as an integral charge electrode. In an alternative, the passage may have a stainless steel liner instead of an ITO coating, the stainless steel liner having viewing apertures to allow visual inspection of ink jet break-up.

The clamping nut 864 comprises a body, defining an outer surface 865 and a hole 867 having an internally threaded portion 863, and a shoulder 866. The shoulder 866 is disposed circumferentially about the hole 867. The threaded portion 863 is coupled to the nozzle body 832 by a threaded interface with the nozzle body socket 878, which has a complementary external thread.

The shoulder 866 is configured hold the charge electrode coupling 862 against the nozzle body 832 by contacting the flange 880 of the coupling, forcing the flange against the nozzle body socket 878. Turning the clamping nut 864 results in variation of the axial position of the clamping nut 864 relative to the nozzle body socket 878. By varying the axial position of the clamping nut 864, an axial clamping force can be applied by the shoulder 866 to compress the coupling flange 880 against the nozzle body socket 878. By varying the axial position of the clamping nut (i.e. by varying the torque applied to the clamping nut), the axial clamping force can be varied. The clamping nut 864 is thus operable by turning it between an adjustment configuration where the charge electrode coupling 862 is loosely held so as to allow relative rotation of the charge electrode 860 and the nozzle body 832 and a fixed configuration where the charge electrode coupling 832 is compressed against the nozzle body socket 878 by the shoulder 866, restricting axial and rotational movement of the charge electrode 860, securing its alignment. In the fixed configuration, the nozzle body 832 (by extension also, the nozzle assembly 834) and charge electrode assembly 848 are co-axially coupled and may be considered a single assembly, referred to as the charge electrode-nozzle body assembly.

In use, the clamping nut 864 may be turned by means of an external tool engaging the outer surface 865 which may comprise flats or other engagement features for the external tool to engage and transfer torque through.

The charge electrode 860 is comprises a bearing member 882. As shown in FIG. 25, the bearing member 882 is a toroidal flange (such that it surrounds the charge electrode passage 861) co-axially provided at an end of the charge electrode 860 opposite the nozzle 858 (see FIG. 22) and defines an outer surface 884 which has a truncated spherical geometry. The charge electrode 860 and bearing member 882 are integrally formed as a single component, although in an alternative they could also be separate, rigidly coupled components.

Whilst charge electrode 860 comprises the bearing member 882, in other embodiments the ball joint mount may comprise other components. For example, the charge electrode coupling may comprise a bearing member configured to be received in a socket to form a ball-joint mount (cf. bearing member 882). For example, a charge electrode coupling (which may be transparent) may comprise a bearing member and define a stainless steel-lined passage, forming an integrated charge electrode.

Charge electrode 860 is press fit into the coupling 862. In an alternative, the charge electrode and coupling could be coupled by means of an adhesive-clear UV-cured adhesives are particularly suitable for embodiments where the coupling 862 is glass. Glass couplings may also be bonded to the charge electrode by glass micro bonding or glass slip. In another alternative, the coupling 862 may be overmoulded onto the charge electrode, reducing stresses relative to press-fitting.

Whilst in printhead 800, the nozzle body 832 and charge electrode assembly 848 are co-axially coupled and the bearing member 882 is coaxially provided at an end of the charge electrode 860, alternative arrangements are possible. In an alternative, the nozzle body 832 and charge electrode assembly 848 may be par-axially coupled or coupled at an angle. Additionally, or alternatively, the bearing member 882 may be paraxial or angled with respect to the charge electrode 860.

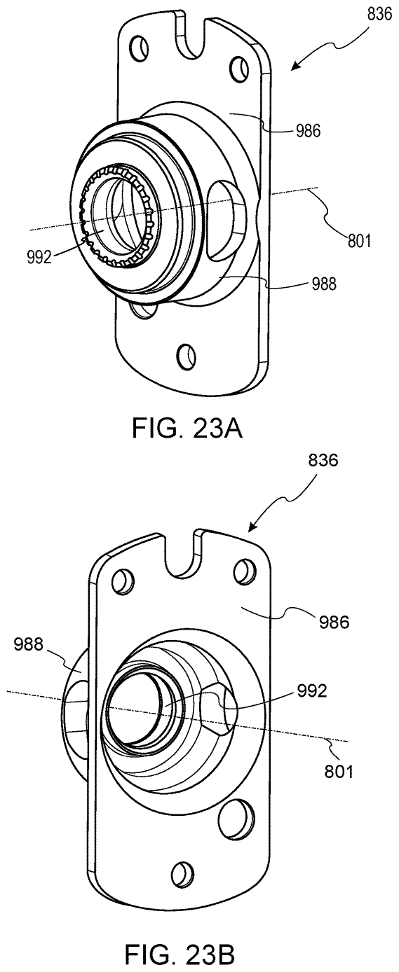

FIGS. 23A and 23B show the charge electrode mount 836 from frontal and rear perspective view, respectively. The charge electrode mount 836 comprises a mounting plate 986 and a toroidal cup 988. The toroidal cup 988 and mounting plate 986 are integrally formed, although in an alternative they could also be separate, rigidly coupled parts.

The toroidal cup 988 has an inner surface having a truncated spherical surface which is a socket 992. The spherical surface is truncated such that there is a hole through the toroidal cup 988 facing the axial direction (as indicated by axis 801).

The bearing member 882 is retained in the complementary socket 992 of the charge electrode mount 836 in a ball-joint mount. The ball joint mount sealingly couples the charge electrode and chamber housing, whilst also permitting rotation about a centre of rotation 894 (see FIG. 22), defined by the common centre of the spherical surfaces of the bearing member 882 and charge electrode mount 836. Put alternatively, the ball-joint permits rotation of the charge electrode in two distinct (i.e. non-parallel) planes disposed such that they intersect the centre of rotation 894. It will be appreciated that combinations of rotations in the two distinct planes may define a conic envelope of motion of the charge electrode 860, wherein the axis of the cone coincides with the nominal ink travel axis 801. The truncated spherical surfaces of the bearing member 884 and the charge electrode mount 836 have substantially the same radius, forming a hydraulically-sealed interface. The charge electrode bearing member 882 may be a snap-fit into the socket 992 of the charge electrode mount 836. It will be appreciated that in order for the charge electrode 860 to snap-fit into the charge electrode mount 836 at least part of the ball-joint mount must be resilient. For example, either or both of the bearing member 882 and the toroidal cup 988 may be composed of a resilient material (e.g. a solvent-resistant engineering plastic) so as to allow sufficient deflection to permit the bearing member 882 to seat in the socket 992 without excessive insertion force, whilst retaining enough interference between the seated bearing member 882 and socket 992 to maintain a hydraulic seal and mechanical rigidity of the ball-joint mount.

As shown in FIG. 21, the mounting plate 986 allows the charge electrode mount 836 to be rigidly coupled to, and hydraulically sealed against the chamber housing 822, aided by an O-ring 894. The hydraulic seal between the chamber housing 822 and the charge electrode mount 836 and the hydraulic seal between the charge electrode mount 836 and the bearing member 882 defines a barrier to fluid communication between the chamber 856 and the rest of the printhead (i.e. region of the printhead outside the chamber 856). Advantageously the above-described ball-joint mount allows the orientation of the nozzle 858 and charge electrode 860 to be adjusted (by relative movement between the printhead housing and the charge electrode) whilst maintaining a hydraulic seal around the chamber 856.

It will be appreciated that the charge electrode and the printhead housing are sealingly coupled as well as movably coupled and so the enclosed cleaning chamber 856 has a variable geometry.

It will be appreciated that the enclosed passage 861 of the charge electrode 860 and the nozzle 858 remain in fluid communication with the chamber so as to enable cleaning of those areas.

In some embodiments, the charge electrode assembly 848 and/or printhead 800 may be configured to permit the charge electrode 860 to rotate up to 10 degrees away from the nominal ink travel axis 801 about the centre of rotation 894, such that the range of motion of the charge electrode-nozzle body assembly defines a cone having a semi-angle of 10 degrees. The range of motion of the charge electrode-nozzle body assembly may be physically limited by mechanical interference between the charge electrode 860 and/or the nozzle body 832 and surrounding components (e.g. the charge electrode mount 836).

In some embodiments, the ball-joint mount may further comprise an O ring retained in a groove defined by the bearing member 882 or the socket 992.

Whilst printhead 800 comprises a separate charge electrode mount 836, in some embodiments the charge electrode mount (including the socket) may be integrally formed (e.g. by moulding) with (and part of) another component of the printhead, for example chamber housing 822. Alternatively, the charge electrode mount may be melded or ultrasonically welded into the chamber housing 822.

In an alternative, the bearing member of the charge electrode and/or the coupling may instead define a socket-like surface configured to pivotally couple to a charge electrode mount defining a convex spherical surface fixed to another component of the printhead, for example chamber housing 822.

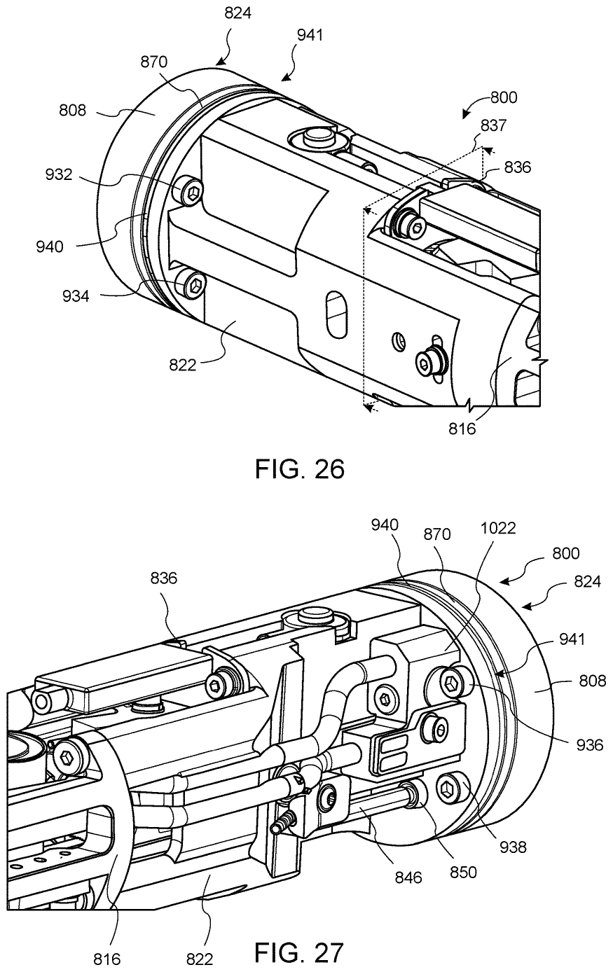

Turning to FIG. 26, a perspective view of part of the print head 800 is provided. With reference to FIG. 19, in FIG. 40 the outer shell 812 and sealing cover 814 are omitted.

From the perspective of FIG. 26, two fasteners 932, 934 are visible. The fasteners 932, 934, along with a corresponding two fasteners on the other side of the chamber housing 822, extend through bores in the chamber housing 822 to releasably couple the sealing mechanism 824 to the chamber housing 822. Described another way, the fasteners 932, 934 extend through bores in the chamber housing 822 and the casing 870, and are received by threaded bores in the end cap 808. Securing the fasteners 932, 934 places the sealing mechanism 824 in engagement with the chamber housing 822 and compresses a gasket 940 therebetween. An interface is defined between the sealing mechanism 824 and the chamber housing 822 (e.g. at face 942 as shown in FIG. 29). The interface is generally labelled 941 in FIG. 26. The chamber housing 822 and components coupled thereto, optionally including the chassis 816, may be referred to as a housing assembly.

Turning to FIG. 27, a perspective view of the print head 800 is provided from a different perspective to that shown in FIG. 26. FIG. 27 thus shows the two other fasteners 936, 938 which are used, in conjunction with fasteners 932, 934 shown in FIG. 26, to releasably couple the sealing mechanism 824 to the chamber housing 822. FIG. 27 also shows the shaft 846, which extends through part of the chamber housing 822 to drive the rotatable body. The combination of the shaft 846 and the socket 850 can be described as providing a mechanical coupling which extends across the interface 941. FIG. 27 also shows a gutter connector block 1022. The gutter connector block 1022 is coupled to the chamber housing 822. The gutter connection block 1022 defines a detachable fluid connection. The gutter connector block 1022, even when coupled to the chamber housing 822, facilitates removal of the sealing mechanism 824 (by virtue of the gutter connector block 1022 only being in sealing engagement with the sealing mechanism 824). Put another way, the sealing mechanism 824 can be urged away from the chamber housing 822 when (only) fasteners 932, 934, 936, 938 are removed. The gutter connection block 1022 defines a fluid pathway which extends across the interface 941. When the sealing mechanism 824 is decoupled from the chamber housing 822, the fluid pathway is separated, and the mechanical coupling is decoupled also, across the interface.

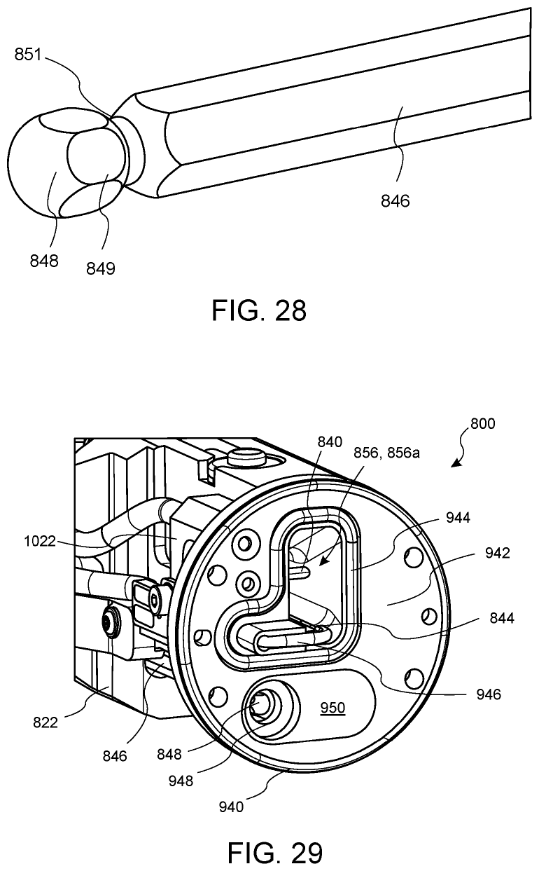

FIG. 28 shows part of the shaft 846 in isolation. The shaft 846 comprises the domed tip 847 at one end. Advantageously, the domed tip 847 provides a greater alignment tolerance when rotationally coupling the shaft 846 and the socket 850 (see FIG. 26) if the sealing mechanism 824 is removed and is then reattached (e.g. following servicing). Put another way, the incorporation of the domed tip 847 provides some axial play between the axes of rotation of the shaft 846 and the socket 850 which receives the shaft 846. Rotational coupling features, in the form of a hex pattern in the illustrated embodiment, are labelled 849 and surround the domed tip 847. It is by the rotational coupling features 849 that the shaft 846 is rotationally coupled to the socket 850 (e.g. the socket 850 comprising a corresponding internal profile to the outer profile of the shaft 846). Similarly, the same rotational coupling features extend along the extent of the shaft 846, and provide a rotational coupling between the shaft 846 and the driving motor (optionally via a gearbox). A narrowed neck 851 is also defined proximate the domed tip 848. Like the domed tip 847, the neck 851 provides a greater (axial) alignment tolerance between the shaft 846 and the socket 850.

Turning to FIG. 29, a perspective view of the print head 800 is provided with the sealing mechanism 824 removed.

From the perspective of FIG. 29 an end face 942 of the chamber housing 822 is visible. The gasket 940 is shown seated on the chamber housing 822. A gasket 944 is also shown seated in the end face 942. The gasket 944 extends around the chamber 856, specifically the first portion 856a defined by the chamber housing 822. Part of the high voltage deflection electrode 840 is also visible in FIG. 29 (albeit within the chamber 856). The gutter 844 can also be seen in FIG. 29. The gutter 844 comprises a gutter aperture defined at an end of gutter line 946. As will be appreciated from FIG. 29, the gutter 844 remains in-situ, positioned relative to the chamber housing 822, even when the sealing mechanism has been removed. Advantageously, this means the alignment of the nozzle and charge electrode assembly, with respect to the gutter 844, is maintained even if the sealing mechanism 824 is removed for maintenance.

FIG. 29 also shows the domed tip 847 of the shaft 846 exposed through an aperture 948 defined in the end face 942. Recess 950 is also defined in the end face 942 and is configured to receive the gearing arrangement 872.

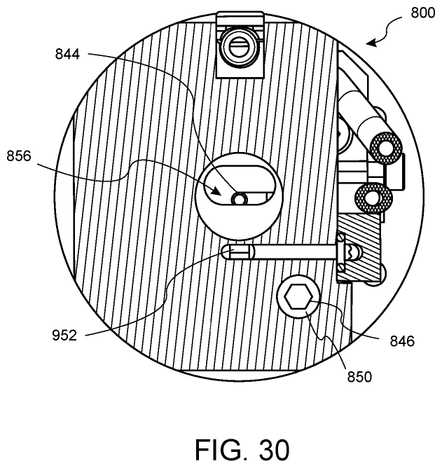

Turning to FIG. 30, a cross-section view of the print head 800 is provided about a plane 837 schematically labelled on FIG. 26. FIG. 30 is therefore a cross-section view taken just beyond the charge electrode mount 836.

FIG. 30 is taken facing towards the gutter 844. FIG. 30 thus shows a line of sight of the gutter 844 through the chamber 856 from the perspective of where the charge electrode-nozzle body assembly is installed (the hole of socket 992, best seen in FIGS. 23A and 23B). Advantageously, by providing a line of sight through the chamber 856, so that the gutter 844, specifically gutter aperture thereof, is visible, the charge electrode-nozzle body assembly can be readily aligned with the gutter 844 despite the chamber 856 being an enclosed, or semi-enclosed, geometry. The jet of ink produced by the nozzle 858 can therefore be aligned so that non-deflected ink is received by the gutter 844.

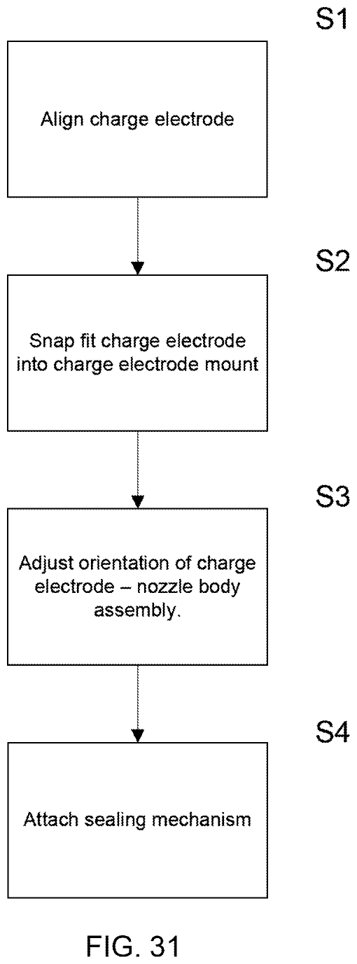

FIG. 31 schematically illustrates a method of aligning or adjusting printhead 800, which may form part of a factory set-up procedure during manufacturing.

At a step S1, the charge electrode is aligned. With the mounting arrangement in the adjustment configuration, the charge electrode 860 may be rotated into alignment with the inkjet (see FIGS. 14A-C and associated description). Once aligned, the charge electrode can be fixed with respect to the nozzle 858 by turning the clamping nut 864 putting the mounting arrangement in a fixed configuration. The nozzle body 832 and charge electrode 860 are (adjustably) coupled to one another via the charge electrode coupling 862.

At a step S2, the charge electrode 860 is snap-fitted into the charge electrode mount 836, forming a ball joint mount.

At a step S3, the orientation of the charge electrode-nozzle body assembly is adjusted by rotating the charge electrode-nozzle body assembly in the two distinct planes about the centre of rotation 894 to align the inkjet and gutter 844. Correct alignment (i.e. where droplets of ink that are not used for printing are received by the gutter 844) of the inkjet and gutter 844 may be verified visually (thus necessitating the omission-or removal of sealing mechanism 824 from printhead 800 as shown in FIG. 29. Advantageously, at step S3 the adjustment can correct for the effect of any ink jet misalignment or skew resulting from manufacturing tolerances of nozzle 858 on gutter-ink jet alignment.

At a step S4, the sealing mechanism 824 is attached to the chamber 822 as described with reference to FIG. 27, yielding an adjusted printhead 800.

In some embodiments of the method, the sealing mechanism 824 may be attached to the printhead 800 before step S3, as described with reference to FIG. 27. In such embodiments, the sealing mechanism 824 may be detached prior to step S4 to allow visual inspection of the gutter 844.

In general, the charge electrode 860 is aligned at step S1 before being snap fitted into the charge electrode mount 836. Performing the actions in this order allows easier access to the clamping nut 864 ad charge electrode 860 to effect adjustment and alignment when the nozzle assembly 834 and the nozzle assembly 848 are separated from the printhead. By snap-fitting the charge electrode 860 into the charge electrode mount 836 first, access to clamping nut 864 and the charge electrode 860 may be severely restricted by surrounding components (e.g. chamber housing 822 or charge electrode mount 836), potentially impeding easy adjustment and alignment of the charge electrode 860, whether by an external tool or otherwise.

It will be appreciated that some further assembly of the printhead may be carried out before step S1. Namely, the charge electrode 860 may be press-fitted into the coupling 862, followed by mounting the coupling 862 onto the nozzle body 832 of nozzle assembly 834 with clamping nut 864.

The printhead 800 may be connected to a test fixture for some or all of the above steps, wherein the test fixture provides necessary connections to enable full or partial operation of the printhead. For example, the test fixture may be configured to provide fluid (such as ink) to the nozzle 858, and suction to the gutter 844. In addition, the fixture may be further configured to provide electrical power to the printhead 800, for example to the nozzle assembly 834 for droplet generation.

In printhead 800, the orientation of the charge electrode-nozzle body assembly is adjusted by means of the nozzle cradle 830 and screws 896 as described above. However, in some embodiments, the charge electrode-nozzle body assembly may be adjusted by means of an external alignment tool which may be used to perform step S4 of FIG. 31. Such an external alignment tool could be removably coupled to nozzle body 832 and used to precisely adjust the orientation/alignment of the charge electrode-nozzle body assembly, for example by means of screw mechanisms. On achieving correct alignment of the inkjet and gutter 844, the alignment tool can be removed and the alignment can be fixed or secured permanently or semi-permanently, for example by potting the nozzle body.

It should be noted that the nozzle 858 does not coincide with the centre of rotation 894 (see FIG. 22). As such the point from which a (misaligned) ink jet originates is offset from the centre of rotation 894. Therefore, the angular adjustment of the charge electrode-nozzle body assembly at S3 does not necessarily exactly correspond to the ink jet misalignment angle or skew.

Generally speaking, the guide surface and guide element are configured to cooperate so as to restrict the relative movement of the nozzle and charge electrode to a desired envelope. For example, the desired envelope may comprise partial rotation about an axis. By relative movement, the charge electrode and nozzle may be adjusted such that they are optimally oriented relative to each other. Having been adjusted the guide surface and guide element may also cooperate to fix the adjusted arrangement. The restricted envelope of relative movement may aid ease of adjustment. However, as described above, several different mechanical arrangements are possible.

Maintaining a coaxial relationship between the jet and the charge electrode results in symmetrical forces on the jet, and therefore consistent print quality. Parallel, but offset spatial relationship between the jet and charge electrode causes reduced print quality. Therefore, relationship between the jet and charge electrode as defined by the interaction of the guide surfaces and guide elements is preferably as coaxial as possible, but small offsets may also be acceptable, for example a deviation of approximately 30% from the centre or less.

In addition, the embodiment of FIGS. 10-14B also specifies the use of threaded bolts/screws 318 to provide a fixed configuration of the adjustment mechanisms. Alternative mechanisms such as a lever cam (cf. a bicycle quick-release) could also provide the requisite clamping pressure.

It is also possible to provide guide surfaces and elements so as to allow adjustment by the manufacturer, followed by permanent fixation in the adjusted configuration. Methods of permanent fixation might include various types of adhesives or obstruction of parts of the adjustment mechanism (e.g. bolts 318). In such an embodiment, the charge electrode assembly would not be end-user adjustable.

Other embodiments may permit relative movement between the charge electrode and the nozzle in a movement plane perpendicular to the nominal ink travel axis.

In the embodiment of FIGS. 10-14B, hydraulic seals at the interfaces between the components is provided by additional sealing members: the boot 151 or gaskets 318 or 319. Mechanically the components are located and fixed to each other by means of threaded fasteners and cooperating recesses (e.g. rotator bolts 344 and semi annular slots 347). Alternatively, some or all of the interfaces between the various component parts could be provided with press-fit interfaces, for example male and female Luer tapers. Luer tapers provide both mechanical location and connection in combination with hydraulic sealing through the interaction of press-fit cooperating (conic) tapers. Such interfaces can also be provided with threaded collars for increased security of connection (cf, hypodermic syringes). It will be appreciated that there are a variety of other press-fit interfaces which would also provide both mechanical location and connection in combination with hydraulic sealing.

In the embodiment of FIGS. 10-14B, a charge electrode drain port 217 is located in the nozzle body 143. In another alternative embodiment, it would also be possible to provide a radial conduit in the insulating couple so as to emerge via a drain port in substantially adjacent to, and upstream of, the nozzle. The radial conduit being configured to directly drain, fill or vent into the enclosed cleaning chamber via the drain port at the nozzle face. Both a boot and a ball-joint have been described above as means of hydraulically sealing an enclosed chamber defined by a charge electrode and a chamber housing, whilst facilitating their relative movement-rendering the geometry of the enclosed cleaning chamber variable and adjustable. It will be appreciated that a variable geometry cleaning chamber may be provided by other means. For example, a charge electrode and a chamber housing may be sealingly and movably coupled by a flexible conduit or a resilient membrane.

While embodiments of the present disclosure are described above, it will be appreciated that these are provided by way of example only, and are not intended to be limiting in nature. Indeed, various alternatives and variations to the specific embodiments described herein will be understood to be possible without departing from the scope of the present disclosure. The scope of the invention is defined by the appended claims.

1. A charge electrode assembly for a continuous ink jet printer, comprising:
a charge electrode defining a passage for charging ink droplets, the passage extending from an inlet aperture to an outlet aperture along an ink travel axis, along which an ink jet travels from a nozzle during printing, the electrode being configured to induce a charge on selected ink droplets by capacitive coupling; and
a mounting arrangement configured to couple the charge electrode to a nozzle body, the mounting arrangement being configured to permit movement of the charge electrode relative to the nozzle to compensate for ink jet misalignment.

2. The charge electrode assembly according to claim 1, wherein the mounting arrangement comprises:
an adjustment configuration in which movement of the charge electrode relative to the nozzle to compensate for ink jet misalignment is permitted; and
a fixed configuration configured in which movement of the charge electrode relative to the nozzle is not permitted.

3. The charge electrode assembly according to claim 1, wherein the passage has a first dimension in a first direction perpendicular to a nominal ink travel axis and a second dimension different to the first dimension in a second direction, the second direction being perpendicular to the first direction and the nominal ink travel axis.

4. The charge electrode assembly according to claim 1, wherein a seal is provided between the charge electrode and the nozzle.

5. The charge electrode assembly according to claim 1, wherein the mounting arrangement is configured to permit rotation of the charge electrode relative to the nozzle about a rotation axis that is substantially co-axial with a nominal ink travel axis.

6. (canceled)

7. The charge electrode assembly according to claim 5, wherein the mounting arrangement is configured to permit rotation of the charge electrode relative to the nozzle through an angular extent of at least 45 degrees.

8-9. (canceled)

10. The charge electrode assembly according to claim 2, wherein the mounting arrangement comprises a guide surface, and a guide element configured to be guided by the guide surface, wherein the extent of movement permitted between the charge electrode and the nozzle is at least partially determined by the configuration of the guide surface and the guide element, wherein the guide surface comprises a substantially cylindrical socket and the guide element comprises a cylindrical projecting portion.

11-12. (canceled)

13. The charge electrode assembly according to claim 1, wherein the mounting arrangement comprises a charge electrode coupling, the charge electrode coupling being couplable, in use, to each of the charge electrode and the nozzle body, wherein the charge electrode coupling comprises an electrical insulator configured to electrically insulate the charge electrode from the nozzle body

14. (canceled)

15. The charge electrode assembly according to claim 10, wherein the guide surface comprises a substantially cylindrical socket defined by the nozzle body and the guide element comprises a cylindrical projecting portion defined by the charge electrode coupling.

16. (canceled)

17. The charge electrode assembly according to claim 10, wherein the mounting arrangement comprises:
a clamping nut, wherein the clamping nut comprises:
a threaded portion, configured to thread onto the nozzle body; and;
a shoulder configured to hold the charge electrode coupling against the nozzle body
wherein, in use, the clamping nut is operable by turning between the adjustment configuration where the charge electrode coupling is loosely held and the fixed configuration where the charge electrode coupling is compressed against the nozzle body by the shoulder, restricting axial and rotational movement of the charge electrode relative to the nozzle.

18. (canceled)

19. The charge electrode assembly according to claim 1, wherein the charge electrode assembly further comprises:
a bearing member which at least partially defines a spherical surface, coupled to the charge electrode;
wherein the bearing member is configured to be pivotally coupled to a charge electrode mount, forming a ball-joint, permitting rotation of the charge electrode in two distinct planes about a centre of rotation.

20. The charge electrode assembly according to claim 3, wherein:
the first dimension is at least 0.5 mm; and/or
the first dimension is less than 1 mm; and/or
the second dimension is at least 1 mm; and/or
the second dimension is less than 5mm.

21. The charge electrode assembly according to claim 1, wherein the charge electrode comprises first and second axially disposed regions, wherein the first region is configured to induce a charge on selected ink droplets by capacitive coupling, and the second region, is configured to shield the charged ink droplets
by surrounding at least a segment of said travel axis.

22. The charge electrode assembly according to claim 3, wherein:
the passage has the first and second dimensions in at least a portion of the first axially disposed region,
the passage has a third dimension in the first direction and a fourth dimension in the second direction in at least a portion of the second axially disposed region, and
the third dimension is larger than the first dimension, and/or the fourth dimension is larger than the second dimension.

23. The charge electrode assembly according to claim 1, wherein at least a portion of the charge electrode is transparent, such that the charge electrode is configured to permit monitoring a formation of the ink droplets within the passage.

24-25. (canceled)

26. A printhead for a continuous inkjet printer comprising:
a charge electrode assembly comprising.
a charge electrode defining a passage for charging ink droplets, the passage extending from an inlet aperture to an outlet aperture along an ink travel axis, along which an ink jet travels from a nozzle of a printhead during printing, the charge electrode being configured to induce a charge on selected ink droplets by capacitive coupling; and
a mounting arrangement configured to couple the charge electrode to a nozzle body, the mounting arrangement being configured to permit movement of the charge electrode relative to the nozzle to compensate for ink jet misalignment:
the nozzle, for generating and ejecting the ink jet which subsequently undergoes jet breakup into a stream of the ink droplets for printing;
a deflection electrode, configured to deflect droplets of ink after the droplets of ink have been charged by the charge electrode; and
a gutter for receiving droplets of ink that are not used for printing.

27. The printhead according to claim 26, further comprising a printhead housing, configured to enclose the deflection electrode within a cleaning chamber, the printhead defining a seal between the charge electrode and the cleaning chamber.

28. (canceled)

29. The printhead according to claim 26, further defining an ink aperture configured to permit droplets to exit the printhead for printing, the printhead comprising a sealing mechanism configured to selectively close the ink aperture.

30. The printhead according to claim 26, further comprising a nozzle adjustment mechanism, configured to permit adjustment of the nozzle relative to the gutter to compensate for ink jet misalignment.

31. (canceled)

32. A method of configuring a printhead for a continuous inkjet printer, the method comprising:
adjusting a nozzle of the printhead to align an ink jet ejected from the nozzle with a gutter for receiving droplets of ink that are not used for printing;
securing the nozzle to a body of the printhead in an aligned configuration;
adjusting a position of a charge electrode relative to the nozzle to compensate for ink jet misalignment; and
securing the charge electrode to the nozzle in an adjusted configuration.

33-88. (canceled)
